(19) United States
(12) Patent Application Publication
(10) Pub. No.: US 2016/0364699 A1
(43) Pub. Date: Dec. 15, 2016

(54) DETECTION SYSTEM

(71) Applicant: MODUSTRI LLC, Grand Rapids, MI (US)

(72) Inventors: Brian B. STEKETEE, Grand Rapids, MI (US); Jesse J. RALEIGH, Grand Rapids, MI (US); Robert Ryan PHILLIPS, Comstock Park, MI (US); Donald Paul MCCONNELL, Grand Rapids, MI (US)

(21) Appl. No.: 14/913,836

(22) PCT Filed: Aug. 29, 2014
(86) PCT No.: PCT/US2014/053321

§ 371 Date: Feb. 23, 2016

Related U.S. Application Data
(60) Provisional application No. 61/871,408, filed on Aug. 29, 2013.
(60) Provisional application No. 61/876,399, filed on Sep. 11, 2013.
(60) Provisional application No. 61/883,179, filed on Sep. 26, 2013.
(60) Provisional application No. 61/890,280, filed on Oct. 13, 2013.
(60) Provisional application No. 61/900,316, filed on Nov. 5, 2013.
(60) Provisional application No. 61/954,371, filed on Mar. 17, 2014.

(51) Int. Cl. G06Q 10/00; G07C 5/08; G07C 5/00

(52) U.S. Cl. CPC G06Q 10/20; G07C 5/008; G07C 5/0808

(57) ABSTRACT

An equipment maintenance information system includes a detection assembly, a mobile device and a network. The detection assembly is configured to detect a condition of at least one part of a piece of equipment, and the mobile device is communicatively connected to the detection assembly and the network. The mobile device is configured to provide substantially real-time data based upon both an output received from the detection assembly and data received from the network. In one embodiment, the system includes a case that forms a housing for the detection assembly and removably attaches to a variety of mobile devices.

### BACKGROUND OF THE INVENTION

The present invention generally relates to a method, system, and/or device configured for motorized vehicle maintenance, and a method, system, and/or device configured to provide real-time data relating to component maintenance information. More particularly, the invention relates to a method of telemetry applied to equipment maintenance in which real time analysis includes costing metrics, durability metrics, and failure prediction metrics.

In undertaking a task of equipment inspection, an inspector may commonly employ measuring tools, including manual measuring scales and electrically operated sensors. Inspection measurements have customarily been recorded “pen and paper” style on an inspection log or form. The inspection log is taken “back to the office,” which may literally be an inspector's work office away from the inspected equipment, may be a field office in the form of an inspector's vehicle, and the like. At the office, then, the inspection measurements may be compared with a guidebook from the equipment inspected. Further, parts tables and labor tables may be consulted and judgment made as to the cost of repairing or replacing parts.

Exemplary vehicles that are typically subject to regular maintenance and preventative maintenance programs include heavy duty motorized vehicles such as trucks, buses, earth movers, and vehicles used in the logging and mining industries. Such programs promote high utilization of vehicles and minimize unplanned downtime. Such programs aim to minimize or prevent the failure of equipment by monitoring the current status of various components, and repairing or replacing components before they can cause system failures.

In the typical situation, a vehicle manufacturer provides a maintenance or preventative maintenance schedule for the user of inspector to follow. Such as schedule typically provides a single, uniform schedule for use with the manufacturer's equipment, without accounting for any information specific to the particular piece of equipment.

Known methods of equipment maintenance, including inspection, may fail in various factors, which may waste time and thereby increase cost, including such factors as identification of a poor inspection measurement at the time of taking the measurement, omission of equipment history at the time of inspection, and inability to identify repair cost at the time of inspection, to identify a few.

### SUMMARY OF THE INVENTION

The present invention provides a detection system, for example, for providing information relating to the maintenance of mechanical equipment and the components of mechanical equipment. The system may include a detection assembly configured to detect a condition of at least one part of the equipment, a mobile device communicatively connected to the detection assembly by a first wireless communicative connection, wherein the mobile device is configured to provide substantially real-time data based upon an output received from the detection assembly, and a database communicatively connected to the mobile device by a second wireless communicative connection, wherein the substantially real-time data is based upon data received from the database. The database may be housed locally on the mobile device, or on a network accessible by the mobile device.

According to at least one aspect of the present invention, a detection assembly includes a detection device configured to detect a condition of at least one part of equipment, a processor communicatively connected to the detection device, the processor configured to process data received from the detection device, a transceiver communicatively connected to the processor, the transceiver configured to wirelessly transmit and receive data with a mobile device, such that the mobile device is configured to emit an output based upon the wear data for equipment components and data received from monitoring a corresponding piece of equipment in substantially real-time.

In one aspect of the invention, real-time audible information and visual display may assist a user in taking a proper measurement with the detection device. For example, the device may emit a particular audible tone and/or display a particular image when the user is using the detection device to measure improperly or in an improper location on the wear part, and another particular set of signals when the user is properly using the detection device in the proper location. The audible and visual signals may be based on information such as historical data and known tolerances regarding the particular type, class, make or model of the equipment, which may be stored on a database, either locally on the mobile device or on a network.

According to this aspect of the present invention a mobile device includes a first transceiver configured to wirelessly transmit and receive data with a detection assembly by a first wireless communicative connection, a second transceiver configured to wirelessly transmit and receive data with a network by a second wireless communicative connection, a processor configured to process information received from at least one of the detection assembly and the network, a display device configured to emit at least one image based upon the processed data, an audible enunciator configured to emit at least one audible sound based upon the processed data, wherein the mobile device is configured to emit an output based upon wear data for equipment components and data received from monitoring a corresponding piece of equipment in substantially real-time.

According to at least one aspect of the present invention, the network includes a database configured to store wear data for equipment components, and a transceiver configured to wirelessly communicate with a mobile device, such that the mobile device is configured to emit an output based upon the wear data for equipment components and data received from monitoring a corresponding piece of equipment in substantially real-time.

According to at least one aspect of the present invention, a method for equipment maintenance includes the steps of: detecting a condition of at least one part of the equipment; communicating, wirelessly by a first wireless communicative connection, data based upon the detected condition; providing a substantially real-time output corresponding to the data based upon the detected condition; communicating, wirelessly by a second wireless communicative connection, wear data from a network; and providing a substantially real-time output corresponding to the data based upon the detected condition and the wear data from the network.

According to at least one other embodiment, the present invention includes a non-transitory computer-readable medium having software instructions stored thereon, such that when executed by a processor, such software instructions cause the processor to control the equipment of the controlled vehicle by executing the steps comprising: detecting a condition of at least one part of the equipment; communicating, wirelessly by a first wireless communicative connection, data based upon the detected condition; providing a substantially real-time output corresponding to the data based upon the detected condition; communicating, wirelessly by a second wireless communicative connection, wear data from a network; and providing a substantially real-time output corresponding to the data based upon the detected condition and the wear data from the network.

According to another embodiment, the present invention may streamline the inspection, quoting and ordering process by reducing the amount of information that must be manually entered by a user and/or a manufacturer, such as information regarding a class, make, model and part number for a particular piece of equipment or wear part. For example, the present invention provides a method for inspecting components of equipment, such as a heavy duty equipment vehicle, including the steps of collecting inspection data by at least one of taking a picture, scanning a barcode, typing details, and speaking details, submitting inspection data, processing inspection data, providing a quotation for at least one replacement part, and shipping the at least one replacement part to a customer.

According to at least one aspect of the present invention, a method for inspecting parts of a heavy duty equipment vehicle is provided and includes the steps of submitting an inspection request, shipping at least one inspection tool, performing an inspection, submitting inspection data, processing inspection data, submitting a quotation for at least one replacement part, purchasing at least one replacement part, and shipping the at least one purchased replacement part.

According to another embodiment of the present invention, a system for inspecting parts of a heavy duty equipment vehicle includes a detection assembly, a mobile device in communication with the detection assembly, and a database in communication with the mobile device, wherein at least one of the detection assembly and the mobile device comprises an audible receiving device, and is configured to classify a received sound to diagnose a component making the sound as properly working.

In one exemplary embodiment, the present disclosure provides a method for maintaining a vehicle that utilizes historical information relating to the vehicle, including the steps of: providing a database of machines, wherein each machine is related to at least one equipment model and each equipment model is related at least one component; providing at least one historical measurement the at least one component, wherein at least one historical measurement is based on a measurement of at least one component or an estimated measurement of at least one component; measuring a first component of a first machine; determining a wear rate of the first component based in part on the measurement of the first component and at least one historical measurement of at least one component related to the first component.

In a more particular embodiment, the method for maintaining a vehicle that utilizes historical information further comprises: providing a first equipment model of the first machine; and generating a default inspection form for performing a maintenance inspection on a vehicle based on the components related to the provided first equipment model.

In another more particular embodiment, the method further comprises providing tolerance data related to at least one component, providing a first equipment model and a first component related to the first equipment model, wherein the first component is similar to at least one component; and determining a tolerance related to the first component based in part on the tolerance data related to at least one component.

In another more particular embodiment, the method further comprises providing historical wear data related to at least one component, providing a first equipment model and a first component related to the first equipment model, wherein the first component is similar to at least one component; and determining an estimated wear rate related to the first component based in part on the wear data related to at least one component.

In another more particular embodiment, the method further comprises providing historical data related to a first machine, wherein the historical data includes one or more measurements of a first component of the first machine; determining an estimated wear rate of the first component of the first machine, wherein the estimated wear rate is based in part on the historical data.

In another more particular embodiment, the method further comprises providing a geographic location, an equipment model, a use profile, and a configuration of a second machine, the second machine having at least one component.

In another more particular embodiment, the method further comprises generating a default inspection parameter for the at least one component of the second machine based in part on at least one of the geographic location, the equipment model, the use profile, and the configuration of a second machine.

In another more particular embodiment, the method further comprises providing a geographic location, an equipment model, a use profile, and a configuration of the second machine; and determining a predicted wear rate of at least one component of the second machine based in part on a measured wear rate of at least one component of the first machine, the first machine having in common with the second machine at least one of a common geographic location, a common equipment model, a common use profile, and a common configuration.

In another more particular embodiment, the method further comprises providing a geographic location, an equipment model, a use profile, and a configuration of the second machine; and providing a recommendation for at least one of maintenance and configuration of the second machine based in part on a measured wear rate of at least one component of the first machine, the first machine having in common with the second machine at least one of a common geographic location, a common equipment model, a common use profile, and a common configuration.

In one exemplary embodiment, a portable electronic device is provided. The device comprises a tablet computer including a power source; a case having an outer surface and an interior, the tablet computer being positioned at least partially in the interior of the case; an electronic circuit board positioned between the case and the power source, wherein the electronic circuit board generates heat when receiving electrical power from the power source, at least a portion of the heat being transferred to the tablet computer.

In one exemplary embodiment, a method for securely accessing an electronic report regarding a status of a vehicle is provided. The method comprises: providing a user authentication token; providing a URL address based on encrypting the authentication token; comparing the encrypted token with a reference token; providing access to the electronic report if the encrypted token matches the reference token.

In one embodiment, the detection assembly is configured to removably attach to the mobile device. The detection assembly may include an ultrasonic detector, a case comprising one or more removably attachable connectors, and circuitry configured to wireless communicate with a mobile device, wherein the mobile device emits an output based upon data received from the ultrasonic detector.

These and other objects, advantages, and features of the invention will be more fully understood and appreciated by reference to the description of the current embodiments and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and may be practiced or may be carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a is a block diagram of a detection system, in accordance with at least one embodiment of the present invention.

FIG. 1A is a block diagram of a detection system in accordance with another embodiment of the present invention.

FIG. 2A is a side view of a detection system, in accordance with at least one embodiment of the present invention;

FIG. 2B is a rear view of the detection system of FIG. 1A.

FIG. 3 is a front, right, and lower perspective view of a tablet field case thereof;

FIG. 4 is a front, right, and upper perspective view thereof;

FIG. 5 is a front, left, and lower perspective view thereof;

FIG. 6 is a front, left, and upper perspective view thereof;

FIG. 7 is a front elevation view thereof;

FIG. 8 is a back elevation view thereof;

FIG. 9 is a left elevation view thereof;

FIG. 10 is a right elevation view thereof;

FIG. 11 is a top plan view thereof;

FIG. 12 is a bottom plan view thereof;

FIG. 13 is a front, right, and lower perspective view of a back hosing thereof;

FIG. 14 is a front, right, and lower perspective view of a front bezel thereof;

FIG. 15 is a back, right, and lower perspective thereof; and

FIG. 16 is the view of FIG. 15, showing a tablet computing device in position adjacent a back of the bezel.

FIG. 17 is an alternative schematic of a user interface and a cover.

FIG. 18 illustrates an exemplary system for determining a nonmanufacturer specific set of component tolerances;

FIG. 19 illustrates an exemplary method for determining a nonmanufacturer specific set of component tolerances using the system of FIG. 18;

FIG. 20 illustrates an exemplary system utilizing a plurality of variables to calculate component attributes and provide recommendations;

FIG. 21 illustrates an exemplary method for determining component attributes and providing recommendations using the system of FIG. 20;

FIG. 22 illustrates an exemplary method of continuously improving the forecasting of part lifecycles;

FIG. 23 illustrates an exemplary system utilizing geographical and other indicators to determine cycle predictions, purchase, and default set up parameters;

FIG. 24 illustrates exemplary methods of using the system of FIG. 23.

FIG. 25 illustrates a method for generation of a unique user authentication token for viewing a report.

FIG. 26 is a flow chart of an inspection method, in accordance with at least one embodiment of the present invention;

FIG. 27 is a flow chart of an inspection method, in accordance with at least one embodiment of the present invention;

FIG. 28 is a screen shot in accordance with one embodiment.

FIG. 29 is a screen shot in accordance with one embodiment.

FIG. 30 is a screen shot in accordance with one embodiment.

FIG. 31 is a schematic view of a map of a user interface experience of an equipment maintenance method of the invention;

FIG. 32 is an alternative schematic of a user interface, showing exemplary data elements useful therein;

FIG. 33 is a front view of a detection system according to another embodiment of the present invention.

FIG. 34 is a rear view of a detector assembly according to one embodiment.

FIG. 35 is a front perspective view thereof;

FIG. 36 is a front perspective view thereof with portions removed;

FIG. 37 is a front view thereof with portions removed;

FIG. 38 is an exploded view thereof;

FIG. 39 is a side view thereof;

FIG. 40 is an exploded view of an articulated latch portion thereof.

### DETAILED DESCRIPTION OF THE CURRENT EMBODIMENT

### I. Overview

The present illustrated embodiments reside primarily in combinations of method steps and apparatus components related to a method, system, and/or device for equipment maintenance. Accordingly, the apparatus components and method steps have been represented, where appropriate, by conventional symbols in the drawings, showing only those specific details that are pertinent to understanding the embodiments of the present invention so as not to obscure the disclosure with details that will be readily apparent to those of ordinary skill in the art having the benefit of the description herein. Further, like numerals in the description and drawings represent like elements.

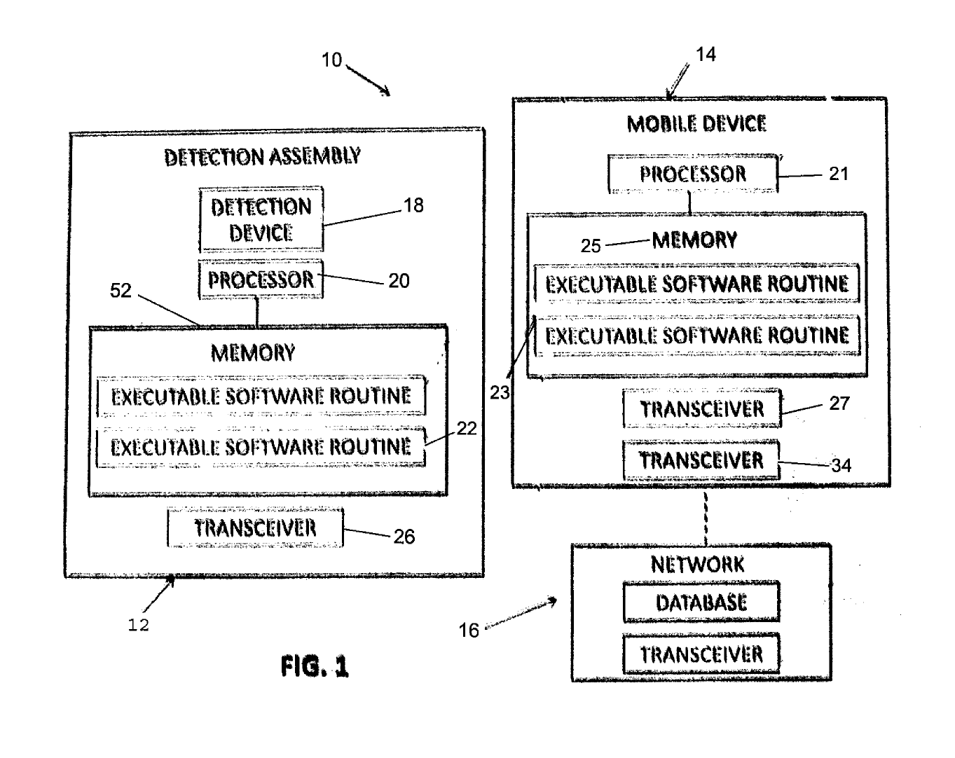

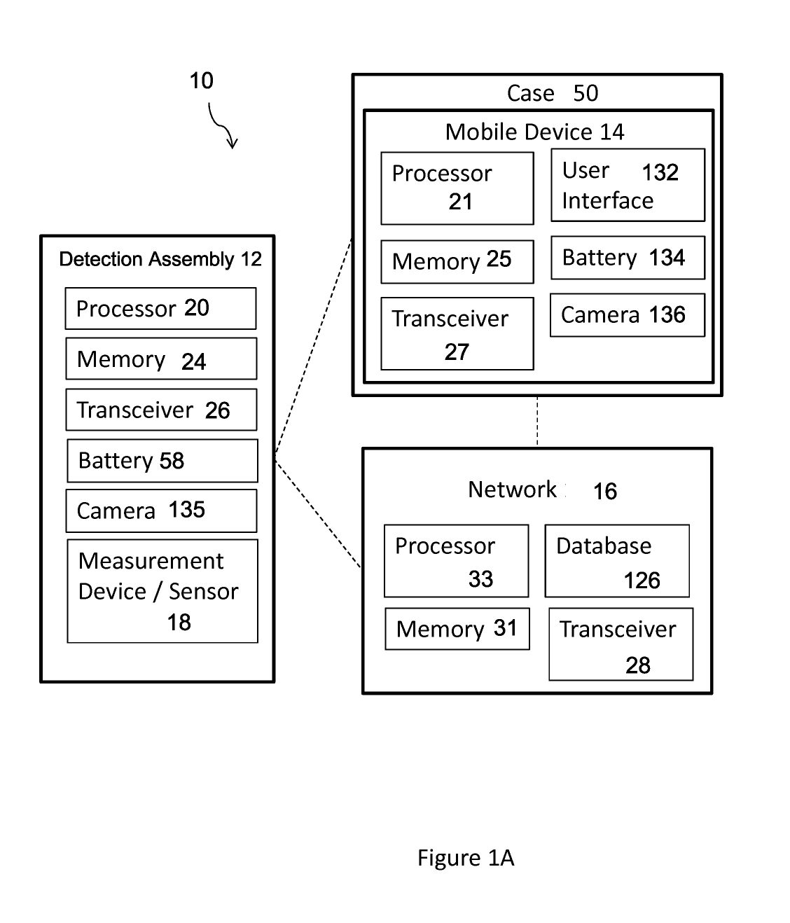

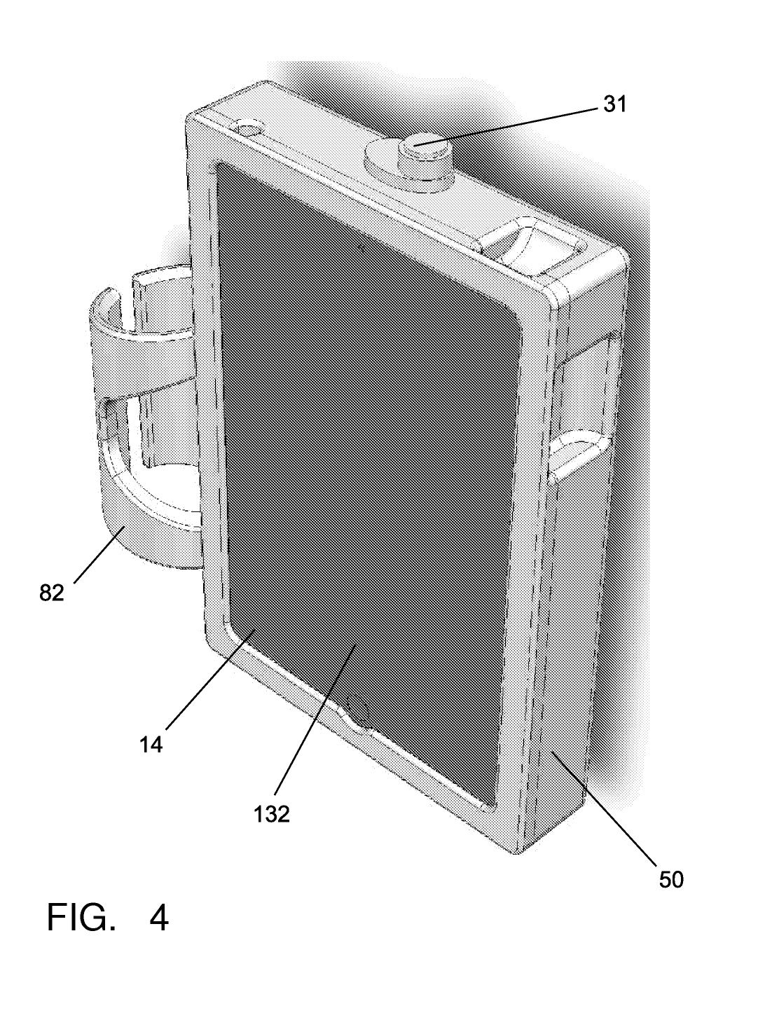

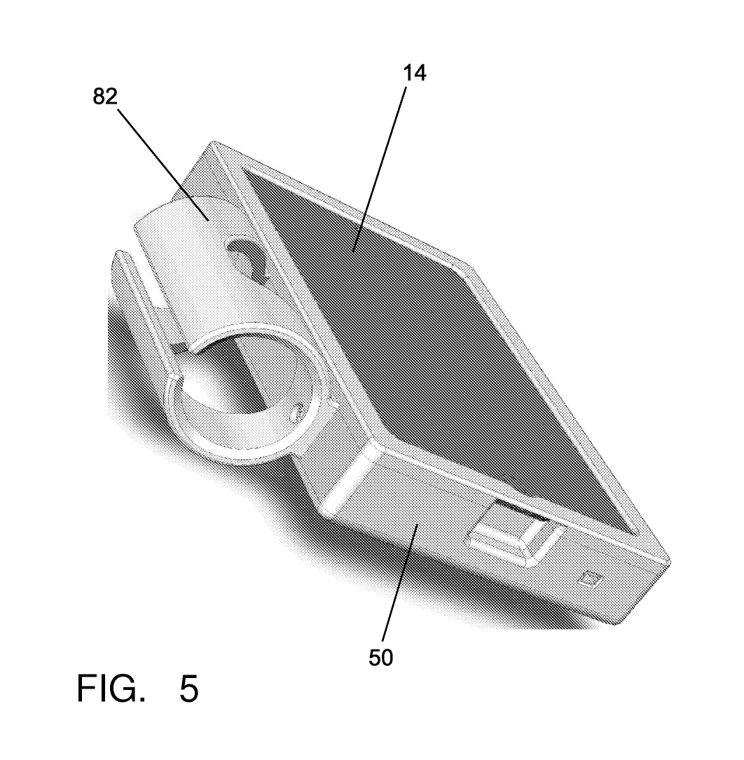

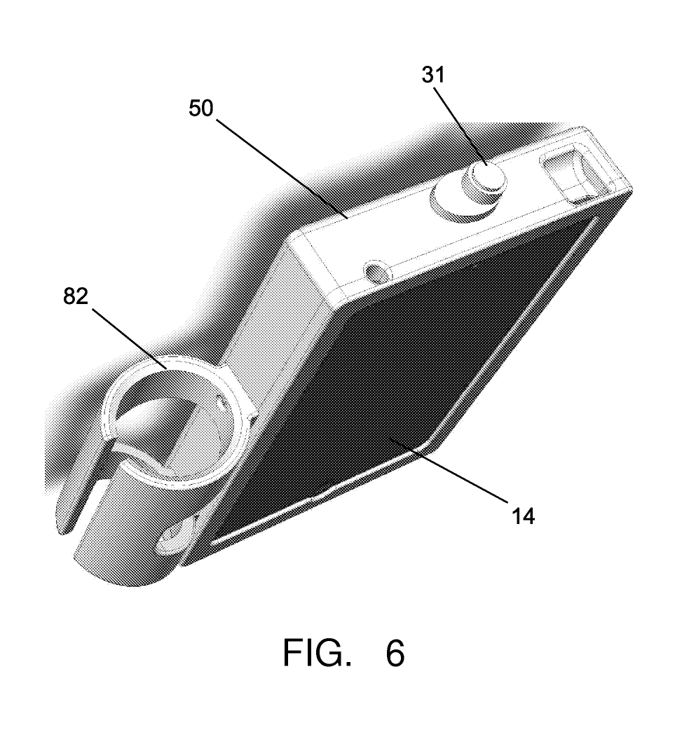

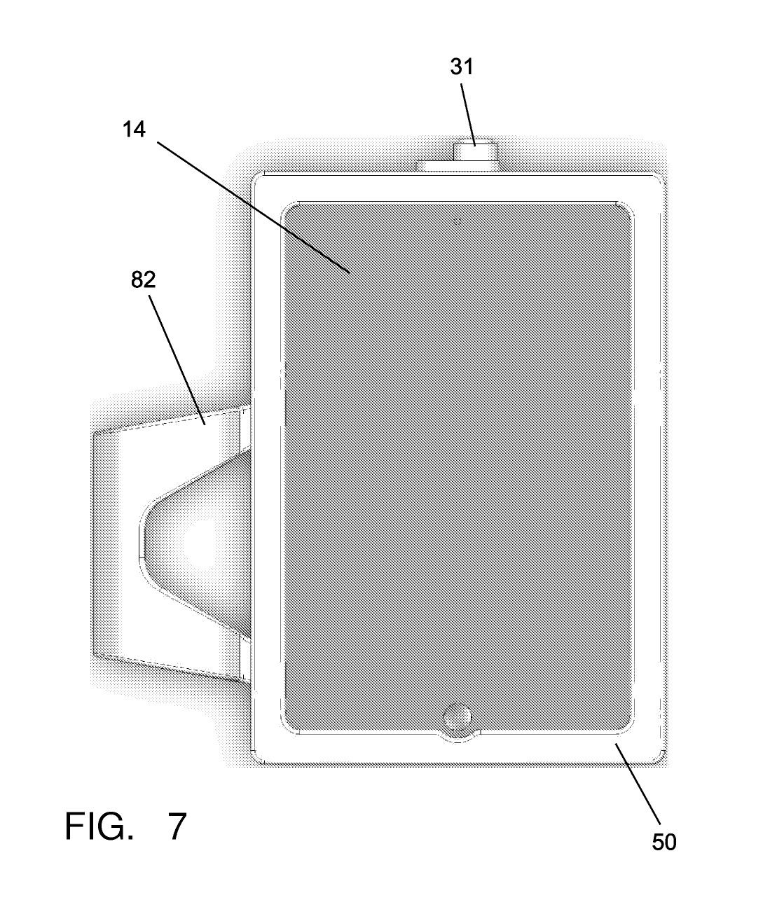

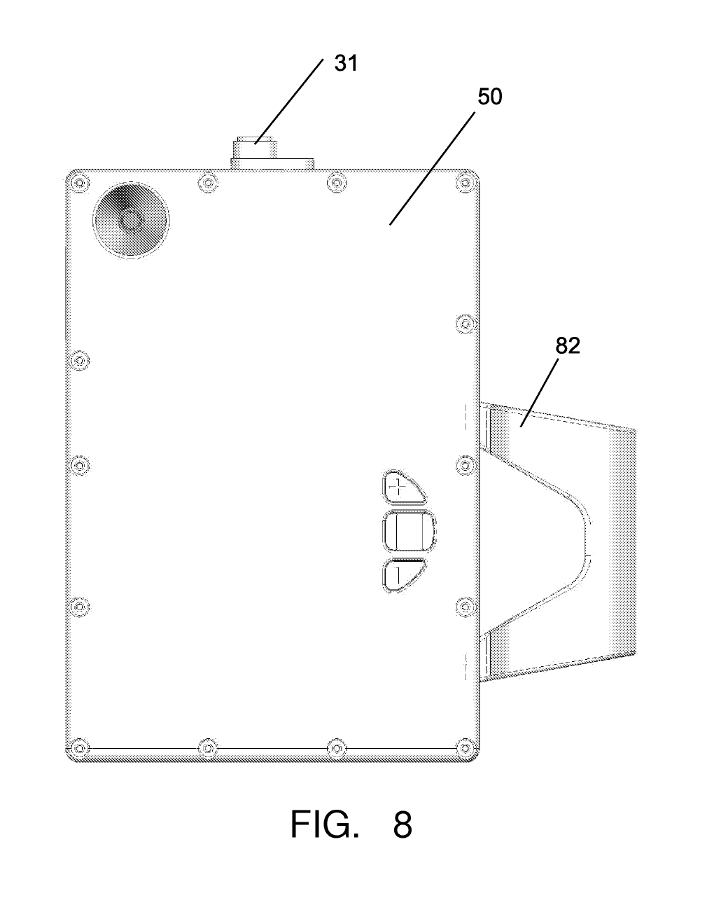

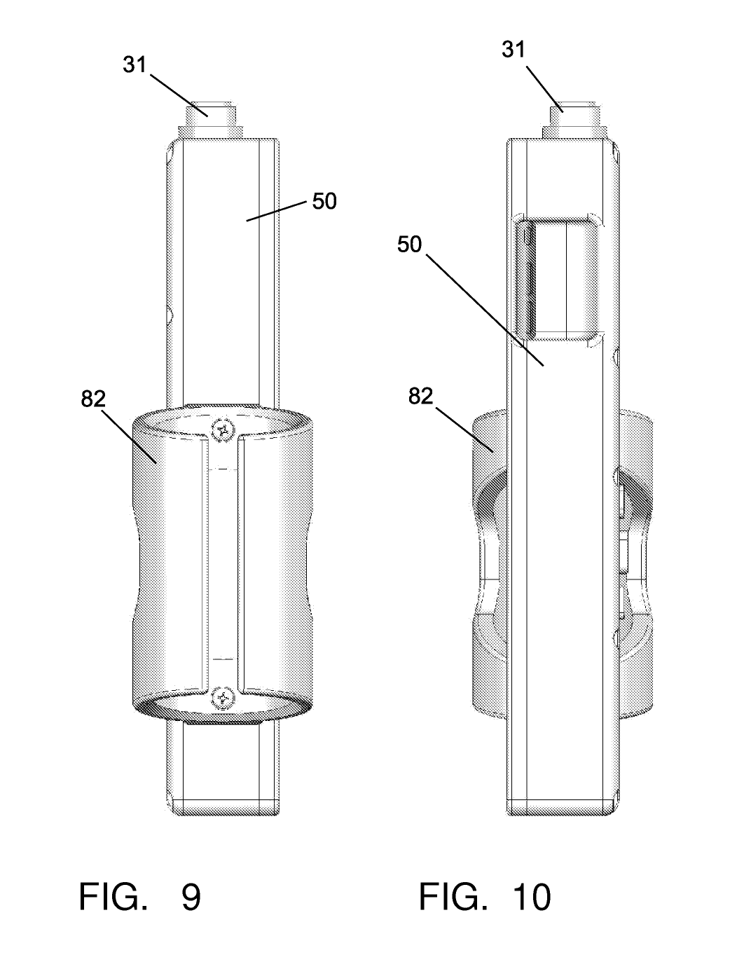

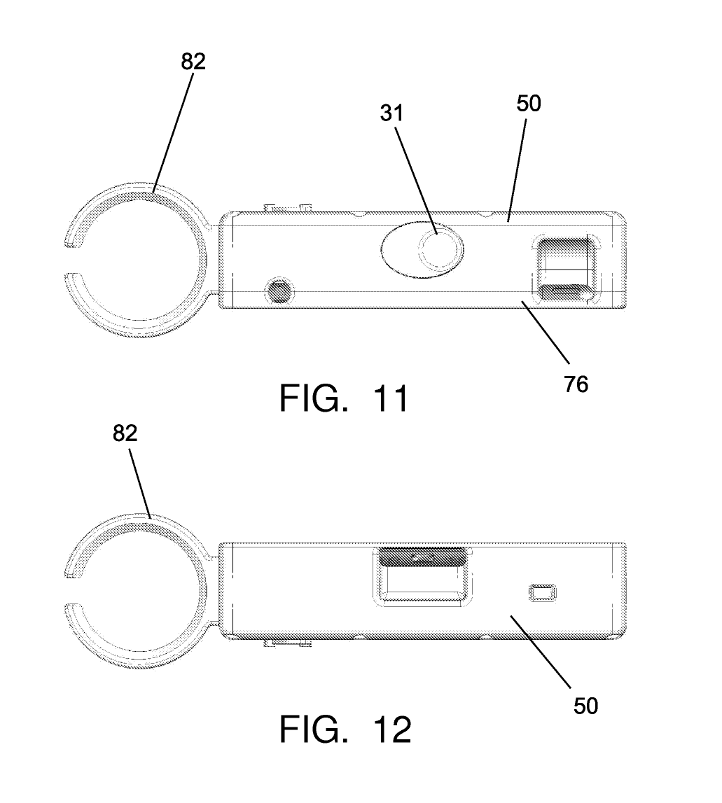

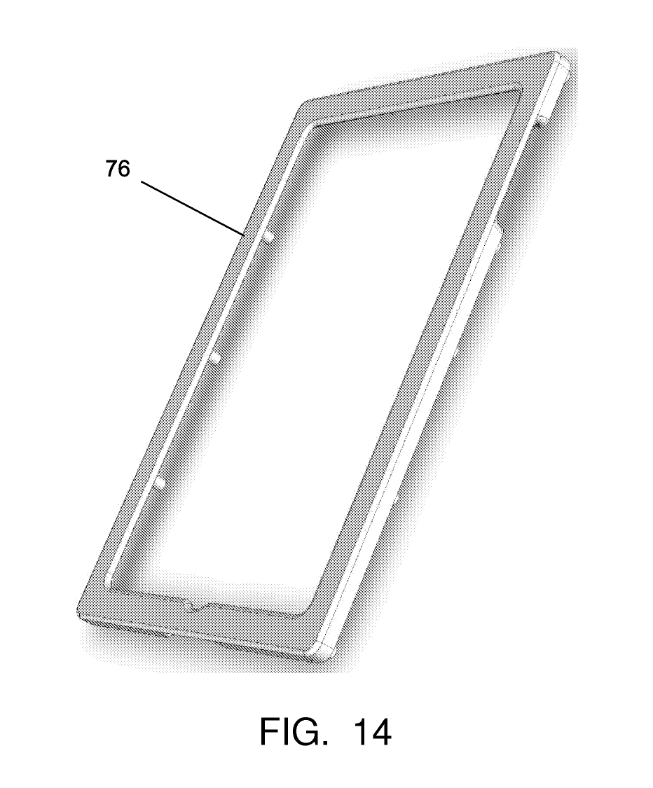

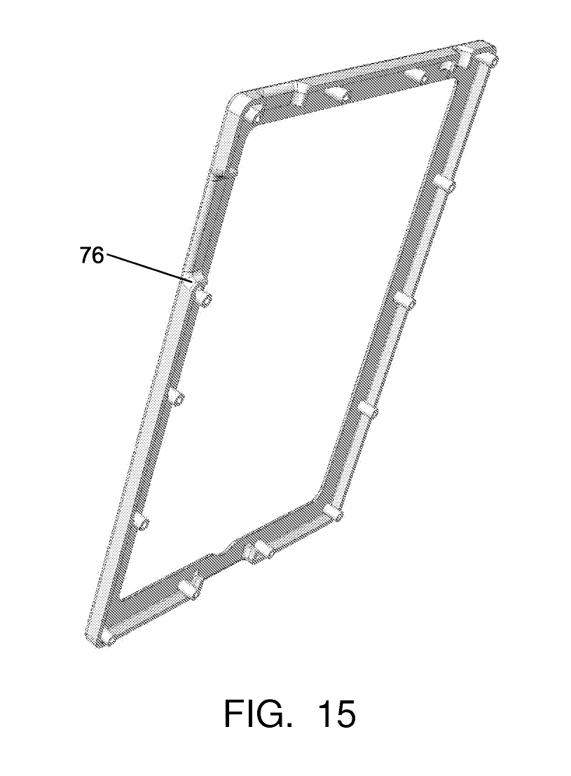

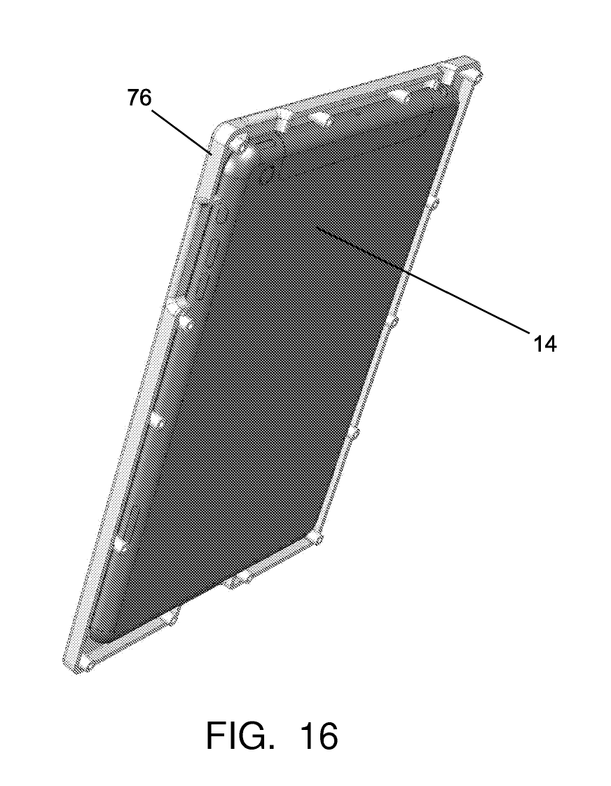

In reference to FIGS. 1-16 a detection system—also referred to as an “equipment maintenance information system” or a “mechanically actuating component maintenance information system”—is generally shown at reference identifier 10. The detection system 10 can include a detection assembly generally indicated at reference identifier 12, a mobile device generally indicated at reference identifier 14, and a network generally indicated at reference identifier 16. The detection assembly 12 may be communicatively connected to the mobile device 14 by a first communicative connection. The mobile device 14 may be communicatively connected to the network 16 by a second communicative connection. The detection assembly 12 may be configured to detect the condition of one or more mechanically actuated components that contact another part or surface (also referred to as “wear components” or “wear parts”), the mobile device 14 can be configured to provide real-time data based upon an output received from the detection assembly 12, and the real-time data can be further based upon data received the network 16, as described in greater detail herein.

By way of explanation and not limitation, in operation, the detection system 10 can be used during an inspection of a wear state of a variety of wear parts. The detection assembly 12 can be configured to detect (e.g., ruler, caliber, ultrasonic, etc.) a wear state (i.e., the amount that the part has deteriorated) of a motorized vehicle part (e.g., brake pad, etc.) and communicate data relating to the measurement to the mobile device 14. The mobile device 14 can provide real-time data based upon the received data, such as, but not limited to audio and/or visual indicators, results, recommendations, the like, or a combination thereof, as described in greater detail herein.

The detection system 10 can be used to monitor, evaluate, and/detect wear, a wear state, and/or condition of one or more parts that mechanically interact with another part or surface, such as, but not limited to, in motorized vehicles (e.g., heavy duty construction equipment), turbines, manufacturing equipment, and other components that wear or deteriorate over their useful life.

### II. Detection Assembly

The detection assembly 12 can include a detection device 18 that is configured to detect one or more characteristics of at least one part. In one embodiment, the detection assembly 12 can also include a processor 20 configured to process data obtained from the detection device 18 by executing one more executable software routines 22 that are stored in a memory device 24. The processor 20 may be positioned on a circuit board 52. The detection assembly 12 may include a transceiver 26 configured to transmit signals to and receive signals from the mobile device 14. The detection assembly 12 may additionally include a battery 58 for providing power to the detection assembly 12.

In one embodiment, the detection device 18 can be an ultrasonic depth detector, a fault detector, and/or another type of wear detector. Additionally or alternatively, the detection assembly 12 can include a cover or case 50 that is configured to house the detection assembly and to removably attach to the mobile device 14. When the detection assembly 12 is removably attached to the mobile device 14, the detection assembly 12 is communicatively connected to the mobile device 14 (e.g., wired connection via a connector, wireless connection, etc.), as described in greater detail herein.

By way of explanation and not limitation, in operation, a user of the detection system 10 can attach the detection assembly 12 when doing an inspection on a vehicle (e.g., turbine, construction equipment, automobile, etc.). Thus, a user can use a mobile device 14 in the ordinary course and then attach the additional hardware of the detection assembly 12, which can at least one of communicate and utilize hardware and/or software of the mobile device 14 to emit an output (e.g., visual, audio, tactile, etc.) to a user. When the detection assembly 12 is not in use, the detection assembly 12 can be disconnected from the mobile device 14.

The detection assembly 12 can be configured to communicate with the mobile device 14 via a wired connection and/or a wireless connection. Examples of wireless connections are, but not limited to, Wi-Fi, BLUETOOTH™, ZIGBEE™, radio frequency, IR, suitable short range wireless communication protocols, the like, or a combination thereof. In at least one embodiment, wherein the detection assembly 12 and mobile device 14 wirelessly communicate with one another, the wireless communication protocol can be configured so that the detection assembly 12 can be detached from the mobile device and distant thereto, so that an inspection can be performed without the detection assembly 12 being removably connected to the mobile device 14.

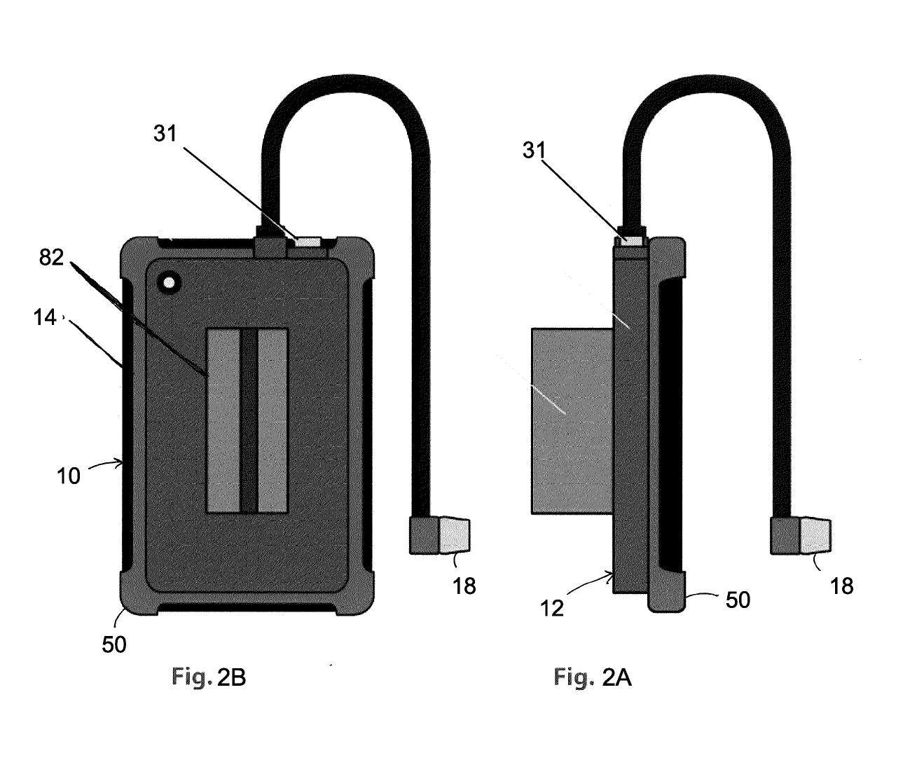

Referring to FIGS. 2A and 2B, according to at least one embodiment, the detection device 18 is an ultrasonic detection device. In such an embodiment, the ultrasonic detection device typically includes an ultrasonic tip. The detection assembly 12 can be configured, such that the ultrasonic tips are removably attached. Thus, different tips can be used for inspecting different pieces of equipment, allow for various levels of accuracy, allow for reading monitoring various materials, the like, or a combination thereof.

The detection assembly 12 can include one or more actuatable devices 31 (e.g., tactile buttons, toggle switches, touch sensors, proximity sensors, capacitive touch sensors, etc.), according to at least one embodiment. The one or more actable devices 31 can be configured to control one or more components of the detection assembly 12, the mobile device 14, or a combination thereof. For purposes of explanation and not limitation, the actuatable device 31 can be configured to control a calibration of the detection device 18, and to control the detection device 18 to take a measurement.

The detection assembly 12 can be configured to be at least one of water resistant, water proof, weather resistant, water repellant, etc. Thus, the detection assembly 12 protects the hardware of the detection device 18. Additionally, the detection assembly 12 can protect the mobile device 14.

Examples of the detection assembly 12 being removably connected to the mobile device 14 are described in more detail below, and include, but are not limited to, friction fit, snap connector, male/female connection, threaded connection, hook and loop fastener, other suitable mechanical connection, the like, or a combination thereof. In yet another embodiment, the mobile device 14 may not be connected to the detection assembly 12, as the wireless connection between the mobile device 14 and the detection assembly 12 may enable the system 10 to function with the mobile device 14 remote from the detection assembly 12, for example, the user may be able to keep the mobile device in his/her pocket while taking measurements with the detection assembly 12.

### III. Mobile Device

Referring now to FIGS. 1-16, the mobile device 14 can be, but is not limited to, a mobile phone, a smartphone, a tablet (e.g., iPad, etc.), a laptop, the like, or a combination thereof. The mobile device 14 can include a processor 21 configured to process data obtained from at least one of detection assembly 12 and the network 16 by executing one or more executable software routines 23 that are stored in a memory device 25. In one embodiment, the memory device 25 may also include a database containing information relating to a variety of characteristics of the equipment or the wear component, such as the type of equipment or motorized vehicle, information relating to a specific piece of equipment of motorized vehicle being inspected, geographical data, accounting data, supply chain management data, productivity data, the like, or a combination thereof. In one embodiment, the memory device 25 includes wear data for one or more pieces of equipment or components of a piece of equipment, the wear data may be information relating to the amount of measured wear for a particular component that will require the specific component to be repaired or replaced.

The mobile device 14 may include a first transceiver 27 configured to transmit signals to and receive signals from the detection assembly 12, and include a second transceiver 34 configured to transmit signals to and receive signals from the network 16. As noted above, typically, such a communicative connection between the detection assembly 12 and the mobile device 14 is a short range communication protocol, such as, but not limited to, WiFi, ZIGBEE™, BLUETOOTH™, the like, or a combination thereof.

In one embodiment, mobile device 14 further includes a user interface 132. User interface 132 may include one or more I/O modules which provide an interface between an operator and mobile device 14. An operator may include a human operator or a computer, machine, or software application interfacing with mobile device 14, detection assembly 12, or network 16. Exemplary I/O modules include input members and output members. Exemplary input members include buttons, switches, keys, touch displays, keyboards, sensors, mouse, and other suitable devices for providing information to processor 21. Exemplary output devices include lights, a display (such as a touch screen), printer, speaker, visual devices, audio devices, tactile devices, and other suitable devices for presenting information to an operator.

Mobile device 14 further includes a battery 134 or other power source for providing power to mobile device 14. Exemplary power sources include rechargeable batteries, including but not limited to nickel-cadmium and lithium ion batteries, and non-rechargeable batteries. Other suitable power sources may also be used.

As discussed in more detail below, the mobile device 14 may optionally include a camera 136. In other embodiments (not shown), the mobile device 14 may include additional features, including one or more measurement devices or sensors. Exemplary sensors include temperature sensors, humidity sensors, altimeters, barometers, as well as GPS or other location detection sensors.

### IV. Cover/Case

As noted above, the detection assembly 12 can include a cover or “ruggedized case” 50 for removably connecting the detection assembly 12 to the mobile device 14. The ruggedized case 50 can be utilized for covering and protecting the detection assembly 12 and at least a portion of mobile device 14.

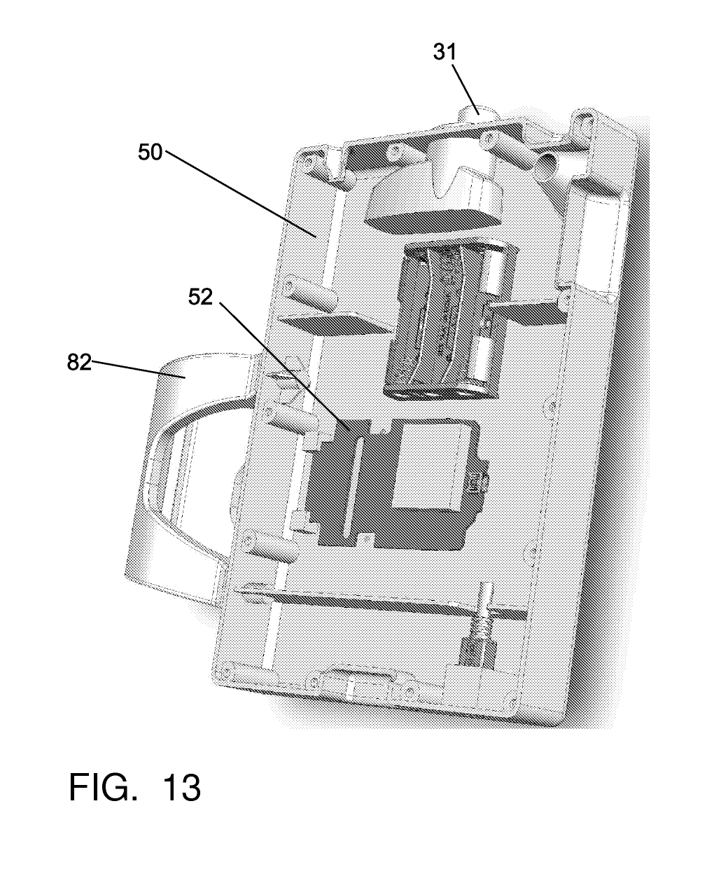

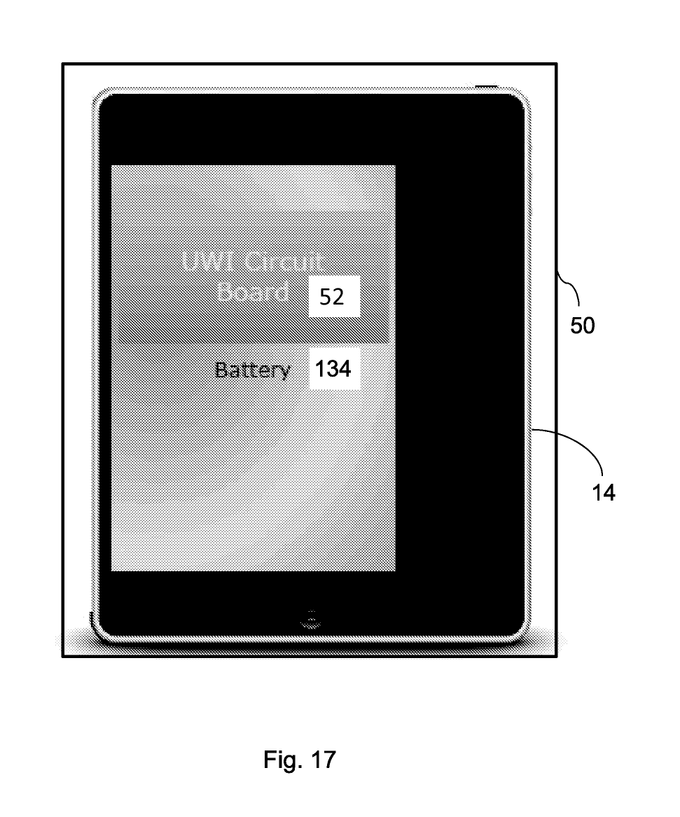

In the illustrative embodiment shown in FIGS. 2A-16, cover 50 may contain and/or include the electronic circuit board 52 of the detection assembly 12, such as the circuit board 52 of a detection device 18 for use in ultrasonic thickness measurement (see, for example, FIG. 13). In the illustrated embodiment, the circuit board 52 is positioned between the mobile device 14 and a back side of ruggedized case 50. In one exemplary embodiment, operation of circuit board 52 generates heat that is at least partially transferred to the mobile device 14. In some embodiments, ruggedized case 50 traps at least a portion of the generated heat from exiting through a back side of ruggedized case 50. In some embodiments, the generated heat allows the mobile device 14 to function at temperatures below the normal operating temperatures. In one example (shown in FIG. 17), the circuit board 52 is aligned with the battery 134 of the mobile device in order to transfer the heat from the circuit board to the battery 134 which may enable operation of the mobile device 14 outside of the standard temperature range for the mobile device 14.

In the illustrated embodiment, the cover 50 further includes a portion 82 for holding a container of ultrasonic couplant. Typically, an amount of the couplant is placed on the area of the wear part to be measured to facilitate the sound transfer between the ultrasonic transducer and the wear part to be tested.

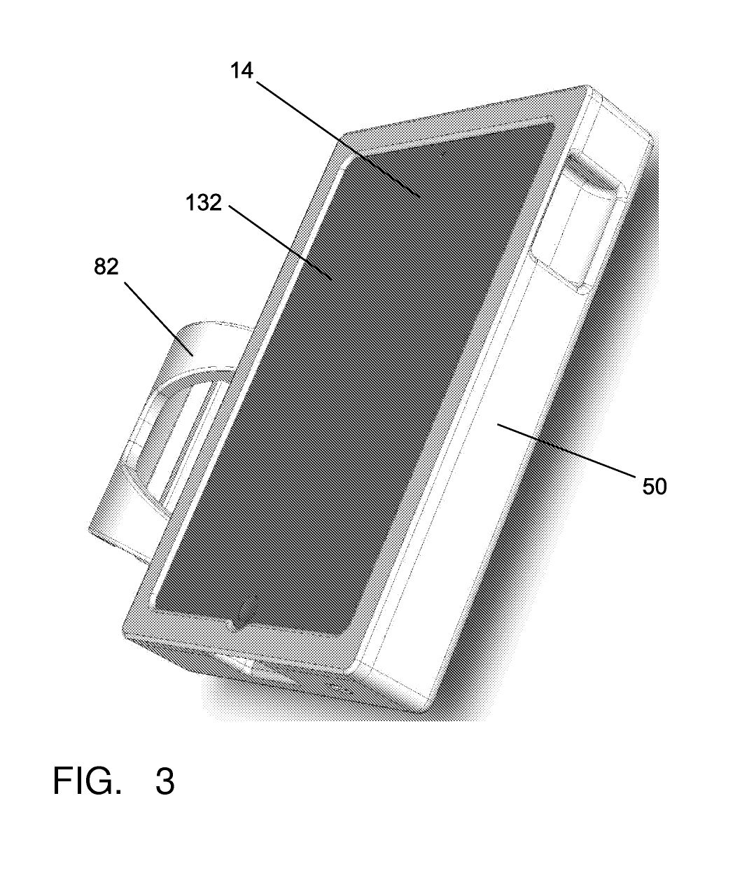

In the embodiment shown in FIGS. 3-16, the case 50 includes a rear portion 70 having a sidewall 74 extending upwardly therefrom. The rear portion 70 forms a housing for the components of the detection assembly 12, and is sized to fit a particular mobile device 14 (multiple sizes may be constructed to accommodate various sizes of tablets). The sidewall 74 substantially encloses the perimeter edge of the mobile device 14. A front frame portion 76 attaches to the sidewall 74 to retain the mobile device 14 within the case 50.

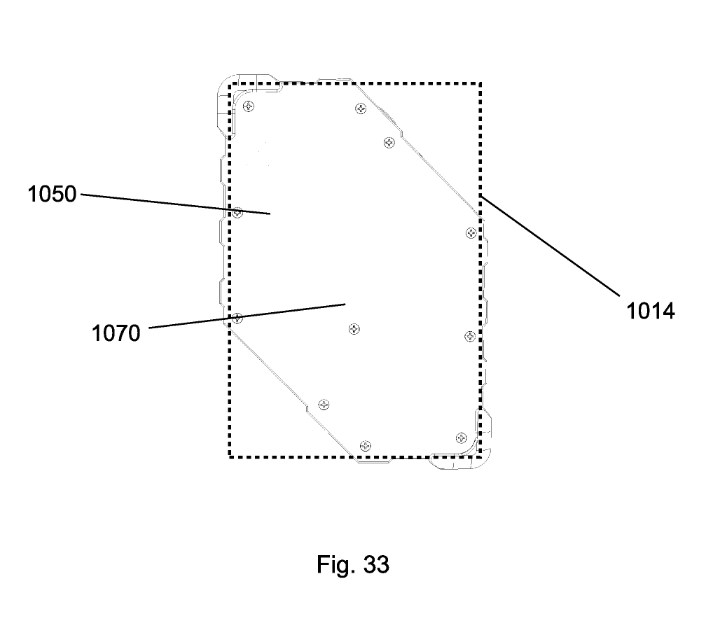

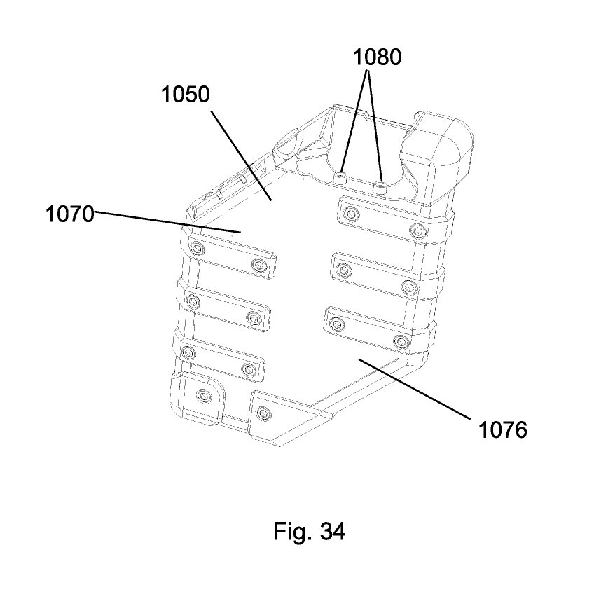

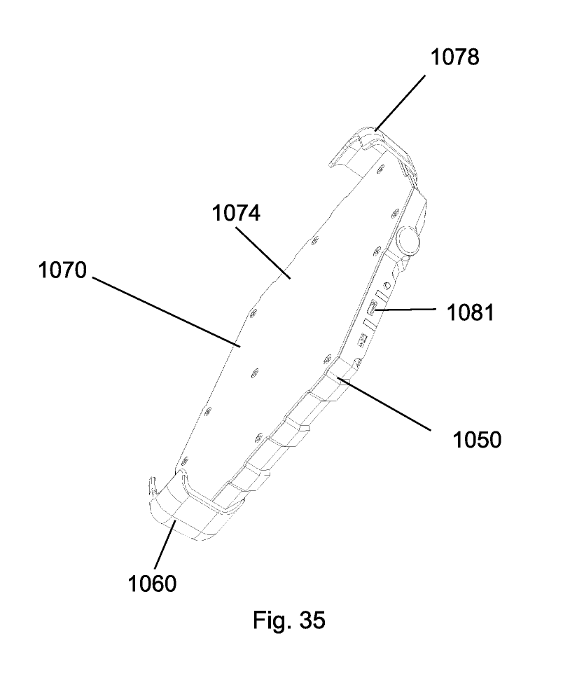

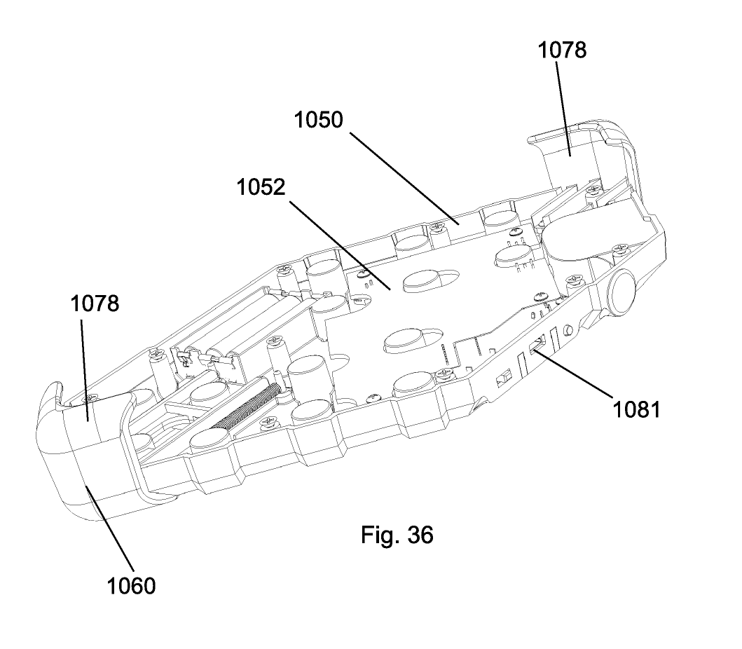

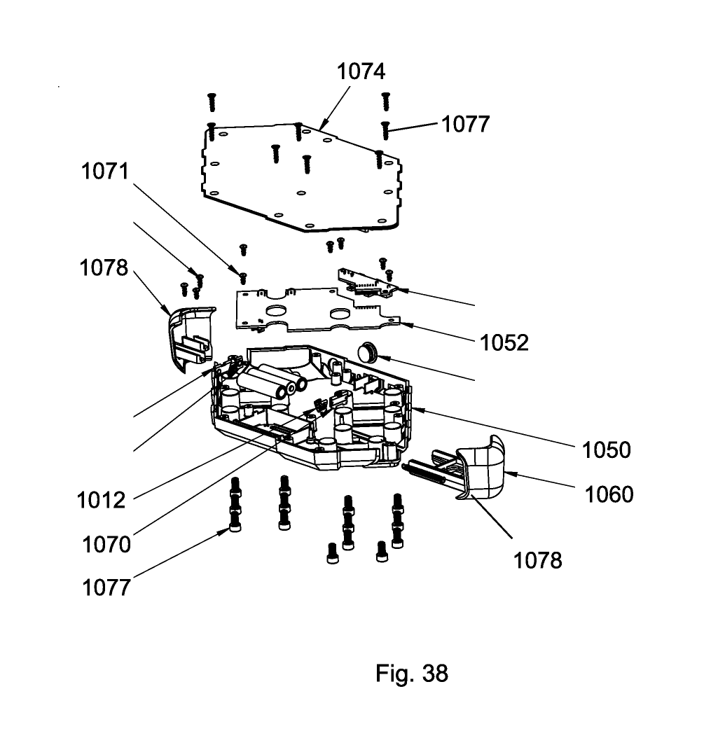

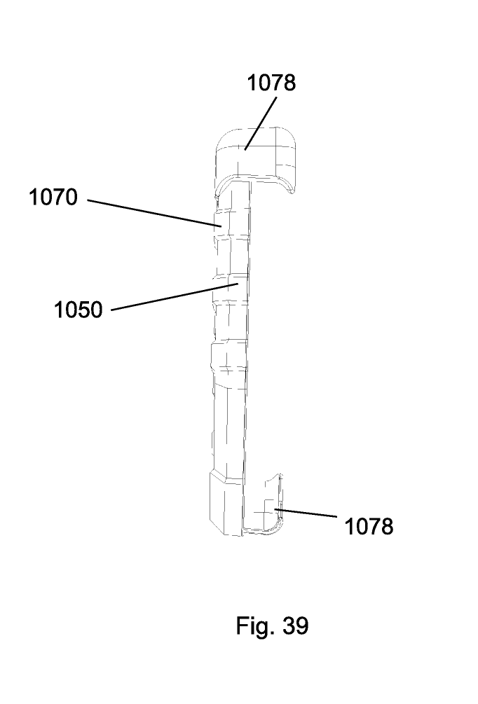

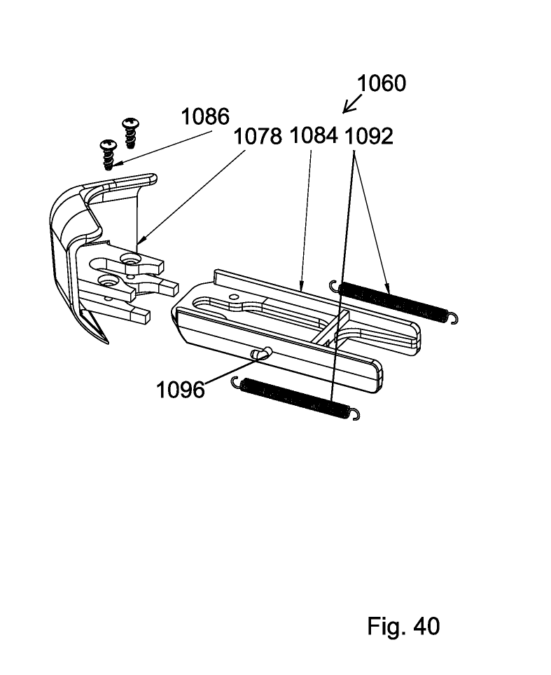

FIGS. 33-40 show another embodiment of the cover 1050, wherein the cover 1050 is designed for removable attachment to mobile devices of various sizes with an articulating latch mechanism 1060. As illustrated, the cover 1050 includes a substrate 1070 that forms a housing for the detection assembly 1012 and removably attaches to the mobile device 1014. FIG. 33 shows a representation of a mobile device 1014 attached to the cover 1050. The substrate 1070 may extend substantially over the rear surface of the mobile device 1014, although in an alternative embodiment, the substrate may extend over only a portion of the rear surface of the mobile device 1014. The substrate 1070 includes an inner portion 1074 facing the mobile device 1014 and an outer portion 1076 opposite the inner portion 1074. As shown in FIG. 38, the inner portion 1074 may be attach to the lower portion 1074 with a plurality of fasteners 1077 to form a housing for the detection assembly 12. In one embodiment, at least one sidewall 1078 extends upwardly from the outer portion 1076 (although it may extend from the inner portion 1074). In the illustrated embodiment, a plurality of spaced apart, independent sidewalls 1078 extend upwardly from the substrate 1070 at opposing diagonal corners of the substrate 1070 to generally enclose one or more corners of the mobile device 1014 and retain the mobile device 1014 to the cover 1050. The sidewalls 1078 may include a lip 1079 extending inwardly from the sidewall 1078 to partially cover a portion of the mobile device 1014 and thus retain the mobile device 1014.

The cover 1050 houses the detection assembly 1012, for example, by housing the circuit board 1052 as noted above, which may be fastened to the substrate 1070 with a plurality of fasteners 1071. As shown, the cover 1050 may additionally include one or more receptacles 1080 for receiving the connectors of an ultrasonic transducer (not shown in this embodiment, but such connectors are generally conventional). Similar to that shown in FIG. 2A, the ultrasonic transducer may include an elongated cable or cables that extend to the ultrasonic tip for taking ultrasonic measurements. The cover may additionally include one or more ports 1081, such as a USB port, for making a wired connection to the mobile device 14, or another mobile device.

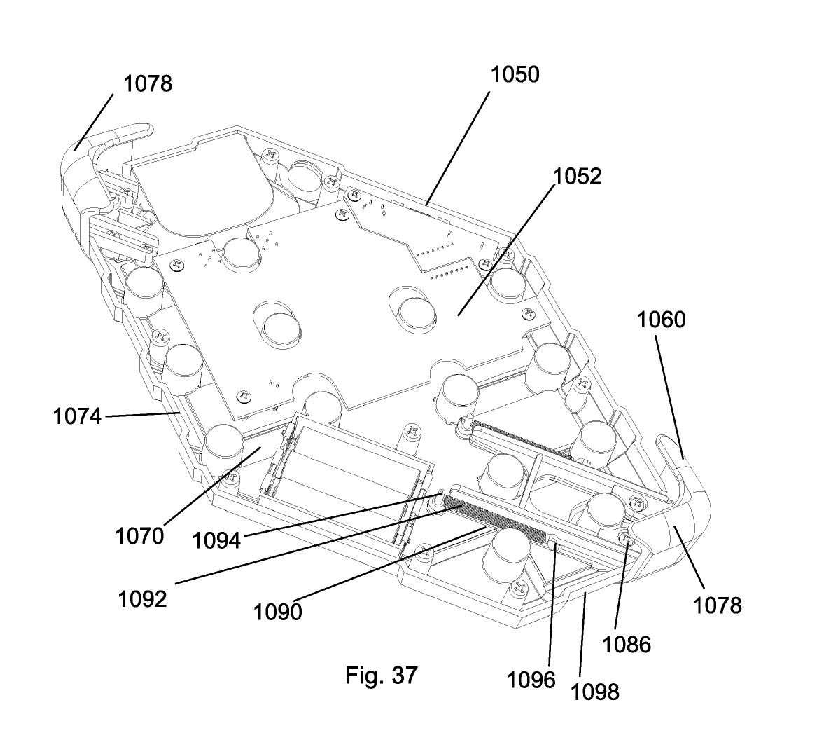

The cover 1050 may include a latch mechanism 1060 for connecting the cover 1050 to the mobile device 1014 and enabling the cover 1050 to removably attach to variable sizes of mobile device 1014. In one embodiment, the latch mechanism 1060 is formed by the articulation of a portion of the sidewalls 1078. In the embodiment shown in FIGS. 33-40, the latch mechanism 1060 is formed by the articulation of one of the plurality of sidewalls 1078. As shown in FIGS. 37, 38 and 40, the sidewall 1078 is attached to a pair of elongated arms 1084, for example, by a plurality of fasteners 1086. The arms 1084 may fit within a pair of guide rails 1090 on the substrate 1070 such that the arms 1084 are slidable within the rails 1090. In the illustrated embodiment, a pair of springs 1092 extend between posts 1094 on the substrate 1070 and hooks 1096 on the arms 1084 to spring load the latch 1060 in a generally retracted position with the sidewall 1078 of the patch 1060 generally flush with the peripheral edge 1098 of the lower portion 1074 of the substrate 1070. When attaching the mobile device 14 to the case 50, a user can manually pull on the sidewall 1078 of the latch 1060 to move the sidewall 1078 to an open position extended away from the peripheral edge 1098 of the substrate 1070, and then insert the mobile device 14 as shown in FIG. 33, and then let the sidewall 1078 retract due to the force of the springs 1092 to retain the mobile device 14 to the case 50. The use of the articulating portion 1060 enables the case 50 to be used with a variety of sizes of mobile device 14.

### V. Network

The network 16 may include a database 126 containing information relating to a variety of characteristics of the equipment or the wear component, such as the type of equipment or motorized vehicle, information relating to a specific piece of equipment of motorized vehicle being inspected, geographical data, accounting data, supply chain management data, productivity data, the like, or a combination thereof (such data may be the same or similar to the data stored on the memory device 25 of the mobile device 14, and may be updated information relating to characteristics of the wear component that is accessible from time to time when accessible by the mobile device). In one embodiment, the network 16 includes wear data for one or more pieces of equipment or components of a piece of equipment, the wear data may be information relating to the amount of measured wear for a particular component that will require the specific component to be repaired or replaced. The network 16 may include a transceiver 28 configured to transmit signals to and receive signals from the mobile device 14. The network may further include a processor 33 for evaluating the information transferred to or received from the mobile device 14. Typically, such a communicative connection between the mobile device 14 and the network 16 is a wireless connection, such as, but not limited, cellular, WiFi, satellite, the like, or a combination thereof. Generally, the wireless communication capability of the communicative connection between the detection assembly 12 and the mobile device 14 is a shorter range wireless communication connection than the communicative connection between the mobile device 14 and the network 16.

Network 16 may include a plurality of hardware and software, including logic implemented in hardware or in hardware executing software. The network 16 may include one or more processors or other structures to implement logic. Exemplary software may be stored in a memory. The memory may include instructions executed by the processor 33. Memory is a computer readable medium and may be a single storage device or may include multiple storage devices, located either locally with the processor or otherwise accessible by the processor 33. Computer-readable media may be any available media that may be accessed by the controller and includes both volatile and non-volatile media. Further, computer readable-media may be one or both of removable and non-removable media.

By way of example, computer-readable media may include, but is not limited to, RAM, ROM, EEPROM, flash memory or other memory technology, CD-ROM, servers, Digital Versatile Disk (DVD) or other optical disk storage, magnetic cassettes, magnetic tape, magnetic disk storage or other magnetic storage devices, or any other medium which may be used to store the desired information and which may be accessed by the controller. In one embodiment, the controller communicates data, status information, or a combination thereof to a remote device for storage, analysis, or carrying out a predetermined command.

In another embodiment, memory may further include operating system software. Memory may further include communications software for communication with a network, such as a local area network, a public switched network, a CAN network, and any type of wired or wireless network. An exemplary public switched network is the Internet. Exemplary communications software includes e-mail software, SMS, Bluetooth communication software, radio frequency communication software, near field communication software and internet browser software. Other suitable software which permit the controller to communicate with other devices across a network may be used.

### VI. System Function

According to one embodiment, at least one of the detection assembly 12, the mobile device 14, and the network 16 may be configured to provide instructions to a user who is performing an inspection. Such instructions can be general instructions or more detailed instructions, such as step-by-step instructions. Thus, the user of at least one of the detection assembly 12, the mobile device 14, and the network 16 can be trained to use the equipment (e.g., a professional inspector) or someone with less education in the area (e.g., user of the equipment being evaluated).

Additionally or alternatively, at least one of the detection assembly 12, the mobile device 14, and the network 16 can be configured to provide at least one indication based upon the reading or data obtained by the detection assembly 12. Such an indication can be a single audio indicator, multiple audio indicators, a single visual indicator, multiple visual indicators, a video display, an image display, the like, or a combination thereof. For purposes of explanation and not limitation, at least one of the detection assembly 12 and the mobile device 14 can be configured to emit a first indicator (e.g, pitch of tone, sequence of tones, color of light, etc.) when the detection device 18 is misapplied (e.g., a faulty reading will be taken), and at least one of the detection assembly 12 and the mobile device 14 can be configured to emit a second indicator different than the first indicator when the detection device 18 is applied correctly (e.g., an accurate reading will be taken). In such an example, at least one of the detection assembly 12, the mobile device 14, and the network 16 can compare the reading or samples thereof from the detection device 18 and compare to one or more thresholds (such as the above noted “wear data”) depending upon the equipment that is being evaluated, wherein one or more indicators can be emitted based upon the comparison to the one or more thresholds.

At least one of the detection assembly 12, the mobile device 14, and the network 16 can be configured to evaluate the data obtained by the detection device 18 and determine the cost for a replacement, according to at least one embodiment. Thus, a real-time quote can be provided for fixing or maintaining the motorized vehicle. Such a quote can be based upon the data obtained by the detection device 18 and processing the data with respect to stored data, such as, but not limited to, wear data and pricing data for the particular piece of equipment or component stored by the mobile device 14 or the network 16. Additional detail regarding a method of utilizing the detection assembly, the mobile device 14 and the network 16 for providing a real time quote is discussed in more detail below.

According to at least one embodiment, at least one of the detection assembly 12, the mobile device 14, and the network 16 can be configured to store data from previous inspections for a specific motorized vehicle (typically referred to herein as historical data). Thus, the data obtained by the detection device 18 during the current inspection can be further compared to historical data to enhance the accuracy and/or quantity of real-time information provided to a user. Additionally or alternatively, such historical data can be used as preventative maintenance, such that an inspection can be scheduled in anticipation of an approximately immanent equipment failure.

In one exemplary embodiment, a method for maintaining a vehicle by utilizing historical information relating to that vehicle includes the steps of: providing a database of machines, wherein each machine is related to at least one equipment model and each equipment model is related at least one component; providing at least one historical measurement the at least one component, wherein at least one historical measurement is based on a measurement of at least one component or an estimated measurement of at least one component; measuring a first component of a first machine; determining a wear rate of the first component based in part on the measurement of the first component and at least one historical measurement of at least one component related to the first component.

The method may further include providing tolerance data related to the at least one component, providing a first equipment model and a first component related to the first equipment model, wherein the first component is similar to at least one component; and determining a tolerance related to the first component based in part on the tolerance data related to the at least one component.

At least one of the detection assembly 12, the mobile device 14, and the network 16 can include geographical data relating to the equipment, such as the particular geographic region of a specific piece of equipment or component, which can be utilized when processing the data obtained by the detection device 18, according to at least one embodiment. Geographical data can account for different soil, terrain, weather, temperature, etc. characteristics that can affect a wear schedule or durability of a motorized vehicle part. Such data can enhance the accuracy and/or quantity of real-time information provided to a user.

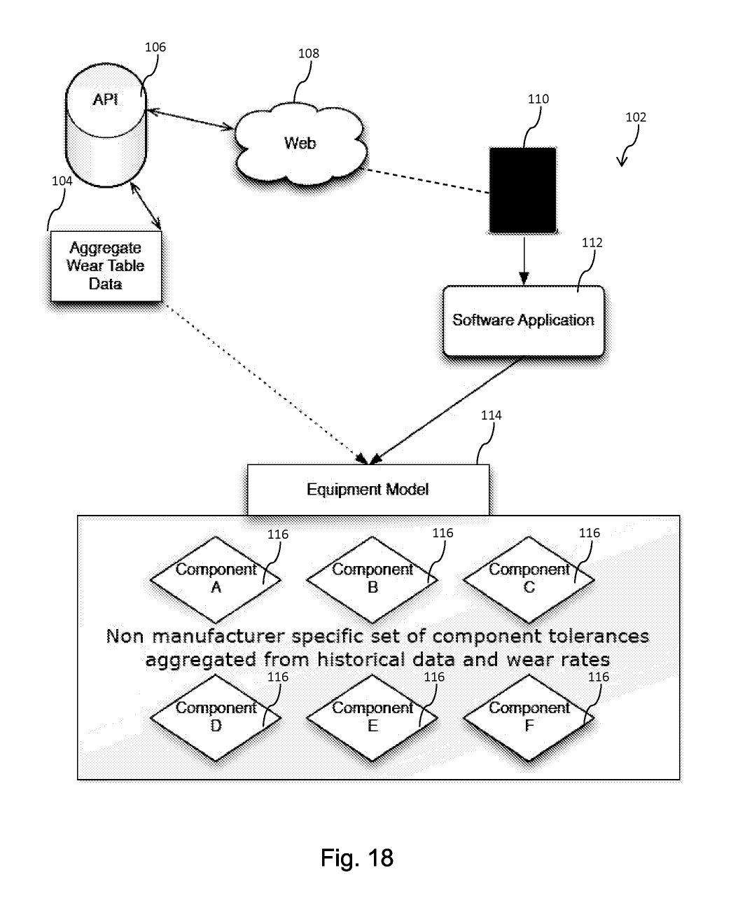

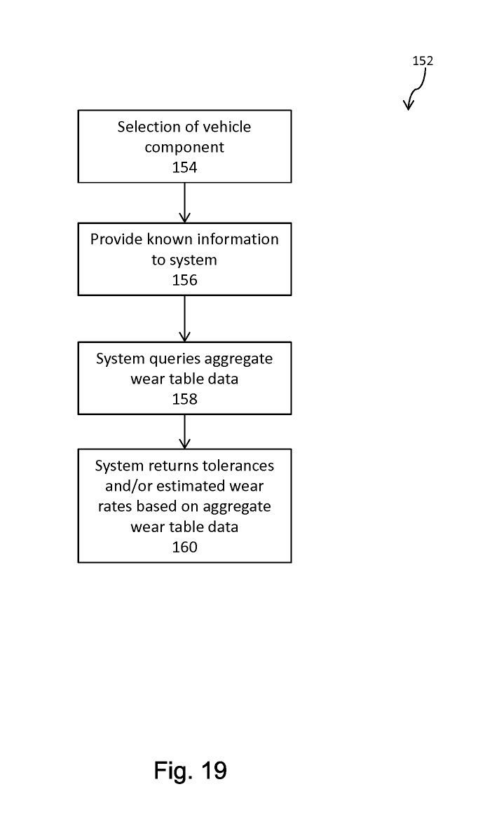

Referring next to FIGS. 18-19, a system 102 (comparable to system 10 described above) and method 152 for determining a non-manufacturer specific set of component tolerances are illustrated. Referring first to FIG. 18, the system 102 includes one or more aggregate wear tables 104 containing relating to a plurality of original manufacturer parts to one or more wear rates or ratios (i.e., wear data). These wear tables 104 are accessible through an application programming interface (“API”) 106, a web-based or cloud-based data service 108, and/or a server 110 to a software application 112. In one embodiment, software application is stored in memory 31 accessible by mobile device 14 (see FIG. 1A). As shown in FIG. 18, software application 112 provides data from aggregate wear tables 104 relating to a user.

Referring next to FIG. 19, an exemplary method of evaluating a part using the system 102 is provided. In block 154, a user selects a component of the vehicle being evaluated. The user may have access to information identifying the original manufacturer of the component, information identifying the original tolerances of the components, and/or information identifying the expected wear rate or ratio of the component. In block 156, the user provides the known information to system 112 through software application 112. Using equipment model 114, system 112 then provides an estimated set of component tolerances and/or estimated wear rates for one or more components 116 associated with the equipment model 114 aggregated from the historical data present in aggregate wear tables 104. In one exemplary embodiment, the estimated set of measurements is a normalized set of tolerances and/or wear rates based on filtering the data in aggregate wear tables 104 using the provided information.

In an exemplary embodiment, given a known machine profile, system 102 provides a listing of potential equipment models 114, from which a user can select the appropriate equipment model 116. Additionally, system 102 provides a manifest of components 116 based at least in part on the selected equipment model 114, and/or a known configuration of the particular machine stored in the machine profile. In one embodiment, after a user confirms the accuracy of the manifest of components 116, system 102 prompts the user to measure one or more components 116 and/or enter a value corresponding to a measurement or evaluation of one or more components 116. In one embodiment, system 102 provides a summary of a current state or condition of the machine based in part on a comparison of the entered measurements or evaluations with historical data from the particular machine and/or the aggregate wear data table 104. In one embodiment, system 102 provides approximate wear status for one or more components 116 when the tolerances for a particular component 116 are unknown, such as the make or part number of the component 116 is unknown, based at least in part on an average or median tolerance as provided in the aggregate wear table data 104 for one or more known components 116 applicable to the given equipment model 114.

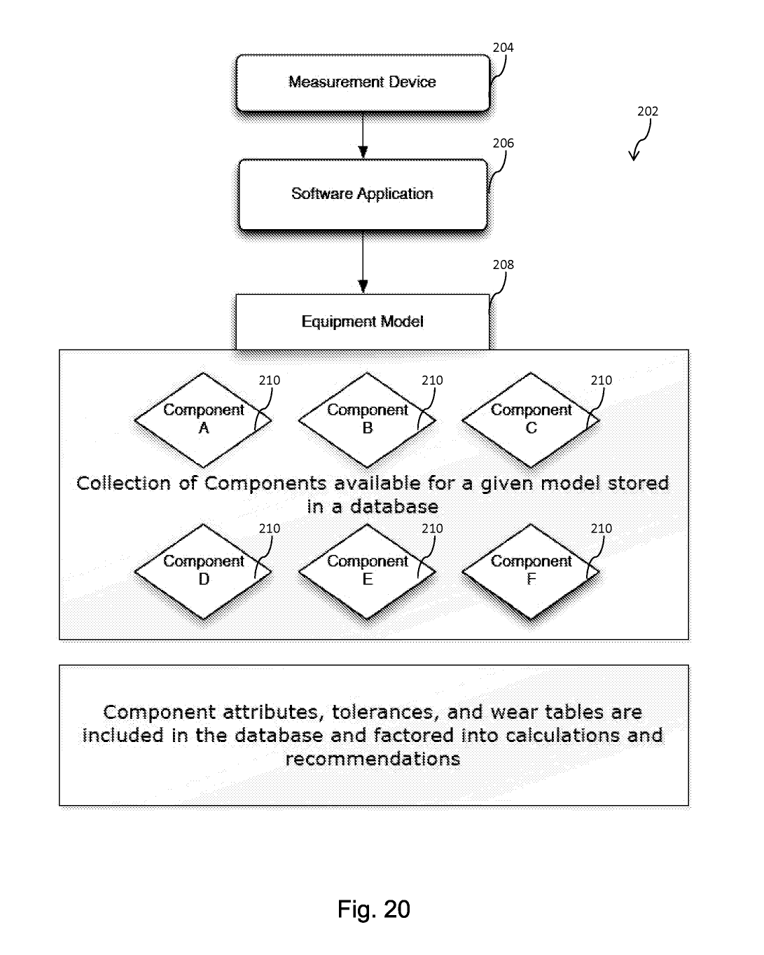

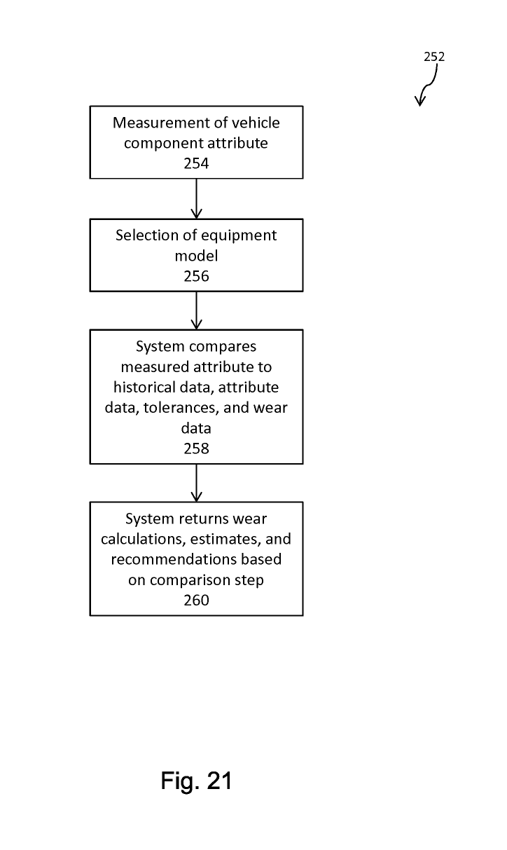

Referring next to FIGS. 20 and 21, a system 202 and method 252 for utilizing a plurality of variables to calculate component attributes and provide recommendations are illustrated. Referring first to FIG. 20, the system 202 includes a measurement device 204. Exemplary measurement devices include the measurement devices or sensors such as detection device 18 of the detection assembly 12 and/or mobile device 14 (see FIG. 1). The measurement device 204 is operatively connected to a software application 206. In one embodiment, software application is stored in memory 24, memory 25, and/or memory 31 accessible by mobile device 14 and/or detection assembly 12 (see FIG. 1). The software application 206 is operatively connected with an equipment model database 208. In one embodiment, equipment model database 208 is a database 126 of network 16. As illustrated in FIG. 20, equipment model database 208 relates a plurality of components 210, illustratively Component A to Component F, to a given equipment model stored in the equipment model database 208.

Referring next to FIG. 21, an exemplary method of calculating component attributes and providing a customer recommendation is illustrated. In block 254, a user uses the measurement device to measure an attribute of a vehicle component. In block 256, the user selects the equipment model and any additional data to enter into the software application 206. In block 258, the system 212 compares the measured attribute with historical data, as well as data related to the attribute and its original tolerances. The system 212 further compares the attribute wear over time with the current attribute measurement to provide calculate the current wear rate. Based on this information, the system 212 may provide additional recommendations, such as recommendations on maintenance and preventative maintenance schedules, recommendations on use, and recommendations on additional equipment or inventory needs. In some embodiments, the system 212 may generate an inspection form based at least in part on the historical data of the measured attribute.

In an exemplary embodiment, for a particular first component 210, such as an idler, exhibiting a first particular wear profile, such as about 80% wear, and a particular second component 210, such as carrier rollers, exhibiting a second particular wear profile, such as about 60% wear, system 202 provides a recommendation in step 260. In this exemplary embodiment, the system 202 recognizes that the idler is a more expensive component to replace and service, and while the Rollers do have adequate remaining life as to indicate that they should be left in service, the relative ease of replacement compared to the idlers makes them a superior candidate for replacement. Using this information, system 202 provides a suitable plan of action based in part on the exhibited wear profiles. For example, one recommendation in step 260 would be to replace the carrier rollers in order to reduce the overall weight and wear of the idler. In some embodiments, recommendations are provided in step 260 based in part on algorithms particular to the equipment model 208 and working environment.

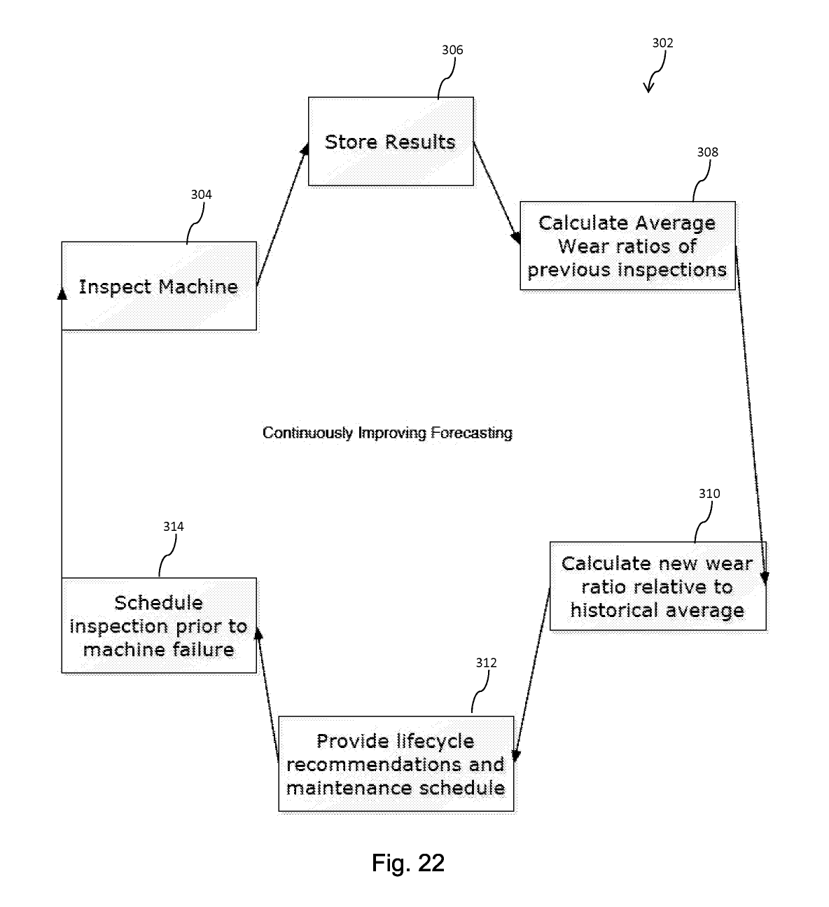

Referring next to FIG. 22, an exemplary method 302 of continuously improving forecasting is illustrated. In block 304, a machine, such as a heavy-duty vehicle is inspected. Inspection of the machine in block 304 may include the visual inspection of one or more component parts of the machine, as well as the measurement of one or more attributes of the one or more components parts. Exemplary component parts and measurements include: carrier roller wall thickness, track sag over several links, chain link thickness at a specific point, track shoe grouser height and/or thickness. Exemplary measurement devices include the measurement devices or sensors such as detection device 18 of the detection assembly 12 and/or mobile device 14 (see FIG. 1). The results of the inspection are stored in memory in block 306. The results of the inspection may be stored in memory 24, 25, and/or memory 31 using mobile device 14 (see FIG. 1A).

In block 308, a database, such as database 126, is queried to return historical inspection results. As illustrated in block 308, this may include the calculation of average wear ratios of the attribute over one or more past inspections. As illustrated in block 310, the current inspection results are used to calculate a present wear ratio, which is then compared to the average wear ratios calculated in block 308. In block 312, lifecycle recommendations and maintenance schedules are provided based on the calculated present wear ratio calculated in block 310, the historical wear ratio calculated in block 308, and/or the current inspection results. Block 312 may also include providing lifecycle recommendations and/or maintenance schedules based in part on a manufacturer suggested or provided schedule, tolerance, or attribute value. For example, if the present and/or historical average wear ratio exceeds that provided by the manufacturer, the system may recommend a more frequent maintenance schedule than that suggested by the manufacturer.

In block 314, a subsequent inspection is scheduled. The inspection may be scheduled to occur at a point in time prior to the expected failure of the inspected component based on the present and/or historical wear ratio calculated in blocks 308 and 310. At the designated time, the vehicle is again inspected in block 304.

In one exemplary embodiment of method 302, database 126 may include two prior inspections, the number of hours per week a machine is in operation, and a calculated wear ratio based upon the amount of time between the prior two inspections and the wear rate during that time. Using this information, the system 202 projects a failure date of the machine, and prompts a user to schedule a follow-up inspection prior to the failure date.

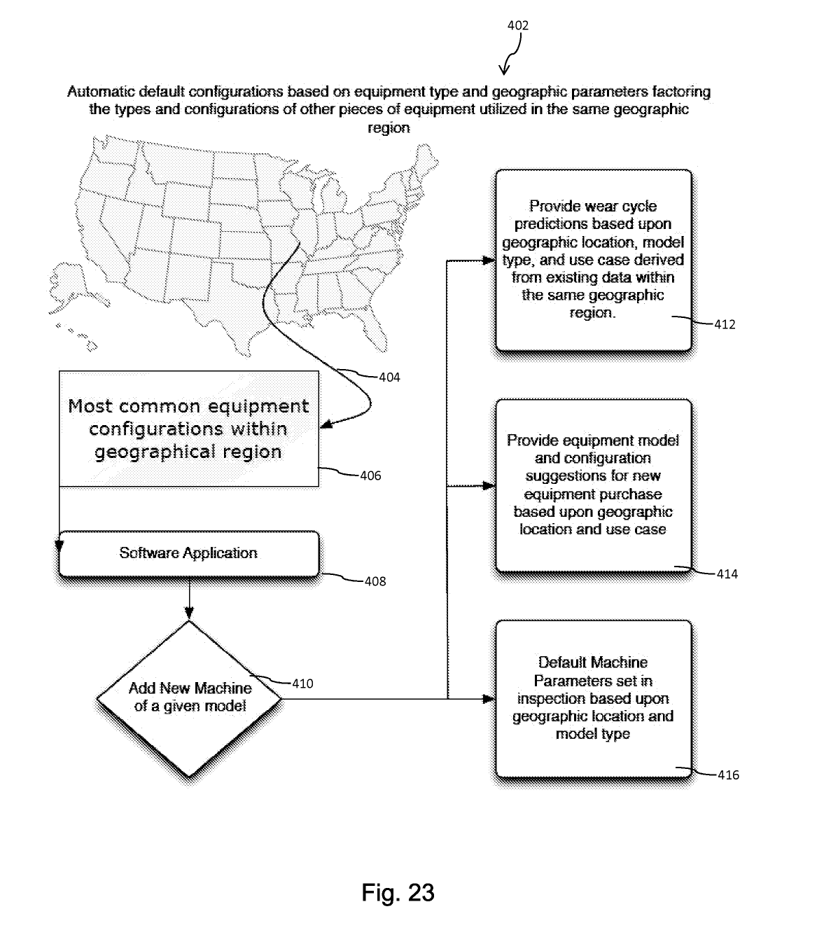

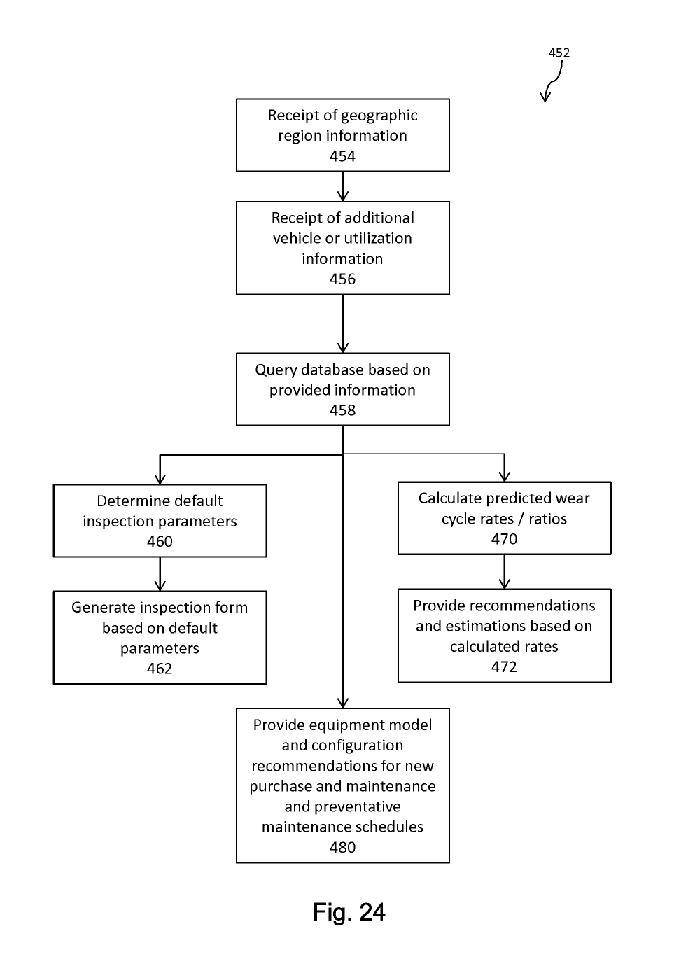

Referring next to FIGS. 23 and 24, an exemplary system 402 and methods 452 utilizing geographical or other indicators are illustrated. As shown in FIGS. 23 and 24, this information can be used to dynamically generate forms 416, provide custom estimate and recommendations based on the use of current equipment 412, and provide recommendations and suggestions for the purchase of new equipment 416.

In one embodiment, the exemplary system 402 includes data relating a machine with a geographical region in which it operates. As illustrated by part 404 in FIG. 23, this information may be provided by The geographic information may be provided by telemetric data provided by the machine itself, or it may be provided by a user through software application 408, such as using a sensor in detection assembly 12 or a GPS or other location detection sensor in mobile device 14. The geographic information is stored with additional information related to the machine in a database 406. Exemplary additional information includes information about the utilization of the machine, the type of work being performed by the machine, the equipment model of the machine, the configuration of the machine, information relating to the weather conditions the machine operates in, information relating to ground conditions or soil types the machine operates in, the current condition of one or more components of the machine, the results of historical or current inspections of the machine, including the inspection of one or more components of the machine. Software application 408 may have access to other databases, such as databases containing Geographic Information Systems (GIS) weather information, and manufacturer component attribute and tolerance values.

The database 406 includes data relating to a plurality of machines. Database 406 can be queried to determine the most common equipment configurations based on one or more selected parameters, including the geographic region, the equipment model, the utilization, the type of work, the configuration, or any other information described above.

As shown by part 410, when a new machine of a given model is added to the database 406, software application 408 can dynamically generate default parameters based on the information related to similar machines already in the database.

In one exemplary embodiment, as shown in part 412, the software application 408 can provide wear cycle predictions based on one or more of the following: the geographic location, the model type, the utilization, the type of work, and the machine configuration using the data in database 406 related to similar equipment.

In one exemplary embodiment, as shown in part 414, the software application 408 can provide configuration suggestions for new equipment purchases based one or more of the following: the geographic location, the model type, the utilization, the type of work, and the machine configuration using the data in database 406 related to similar equipment.

In one exemplary embodiment, as shown in part 416, the software application 408 can provide a set of default machine parameters for inspection based on one or more of the following: the geographic location, the model type, the utilization, the type of work, and the machine configuration using the data in database 406 related to similar equipment.

Referring next to FIG. 24, exemplary methods 452 of using system 402 are further illustrated. In block 454, the system 402 receives information relating to the geographic region in which the machine is being used in. As described above, the geographic information may be provided by a sensor, such as sensor in detection assembly 12 or a GPS or other location detection sensor in mobile device 14. The geographic information may also be provided by telemetric data provided by the machine itself.

Additional information about the machine is also provided in block 454. Exemplary information includes information about the utilization of the machine, the type of work being performed by the machine, the equipment model of the machine, the configuration of the machine, the current condition of one or more components of the machine, the results of historical or current inspections of the machine, including the inspection of one or more components of the machine. This information may be provided by a user interfacing with the software application 408, including using mobile device 14 and/or detection assembly 12 (see FIG. 1A). In one embodiment, software application is stored in memory 24, memory 25, and/or memory 31 accessible by mobile device 14 and/or detection assembly 12 (see FIG. 1A).

In block 458, the software application 408 queries the database 406 to return geographical and additional information for similar machines.

In one exemplary embodiment, as shown in block 460, the software application 408 can then use the information related to similar machines to determine default inspection parameters and in block 462 generate an inspection form based on the default parameters. The user may adjust or modify these default parameters using user interface 32 of mobile device 14 to interact with software application 408.

In an illustrative embodiment, when a new machine is to be inspected 410, a user will select a particular machine model from a list of choices provided by software application 408. Software application 408 will then provide an initial default configuration for that particular machine based on the known configuration of similar equipment 406. For example, if 90% of similar machines within a 10 mile radius of the current location have a first configuration, the default parameters for the newly added machine will be aligned with the first configuration.

In one exemplary embodiment, as shown in block 470, the software application 408 can then use the information related to similar machines to calculate predicted wear cycle rates and/or ratios based at least in part on the historical data of the information for similar machines. In block 472, recommendations and estimations for maximizing component life or minimizing machine downtime can be provided to the customer based at least in part on the historical data of the information for similar machines and calculated predicated values.

In an illustrative embodiment, when a new machine is placed into service 410, software application 408 provides initial wear predications or expectations based in part upon the equipment model, configuration, and/or geographic region of the machine.

In one embodiment, the software application 410 produces the initial wear predictions or expectations based on wear data collected on machines having similar equipment models, similar configuration, and/or used in a similar geographic region to the new machine. In one embodiment, software application 408 identifies crucial maintenance components based on the wear predictions or expectations, as well as a recommended inspection schedule based on an expected use scenario, such as configuration, geographic region, and type of work for the new machine.

In one exemplary embodiment, as shown in block 480, the software application 408 can use the information related to similar machines to provide recommendations and estimations for new equipment models and/or configurations for a customer based at least in part on the historical data of the information for similar machines in a similar geographic area and/or performing a similar type of work.

In an illustrative embodiment, when a new machine is to be placed into service, system 402 provides a recommendation as to equipment model and/or configuration based on the equipment models and/or configurations used within a common geographical area, similar to the part 414 described above.

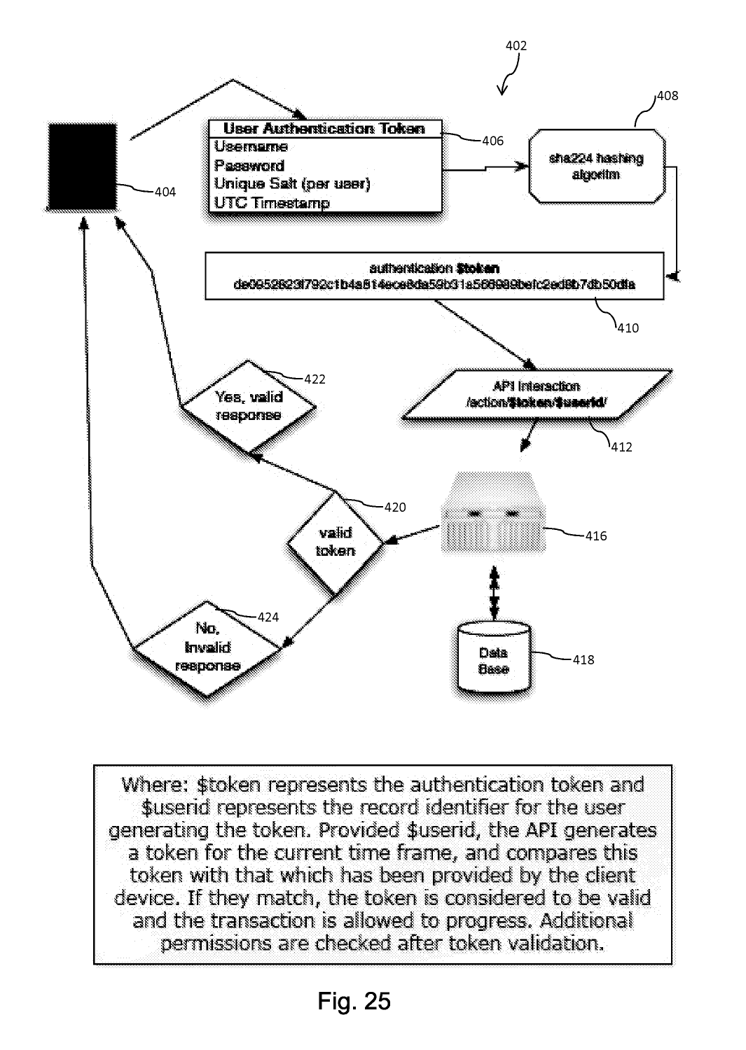

In another exemplary embodiment, shown in FIG. 25, the present disclosure provides a method 402 for generation of a unique user authentication token 406 token for viewing a report. In one embodiment, a permanent link for an inspection report is generated to be included with emailed and printed inspection reports for later retrieval by encoding a unique Identifier for a given inspection as an Integer value, and encoding it. A URI is provided, such as “http://portal.modustri.com/inspection/a093nf/”, which will provide the inspection report to the requesting user for the given inspection. This will work similar to so called “TinyURL” services, also known as URL shortening services.

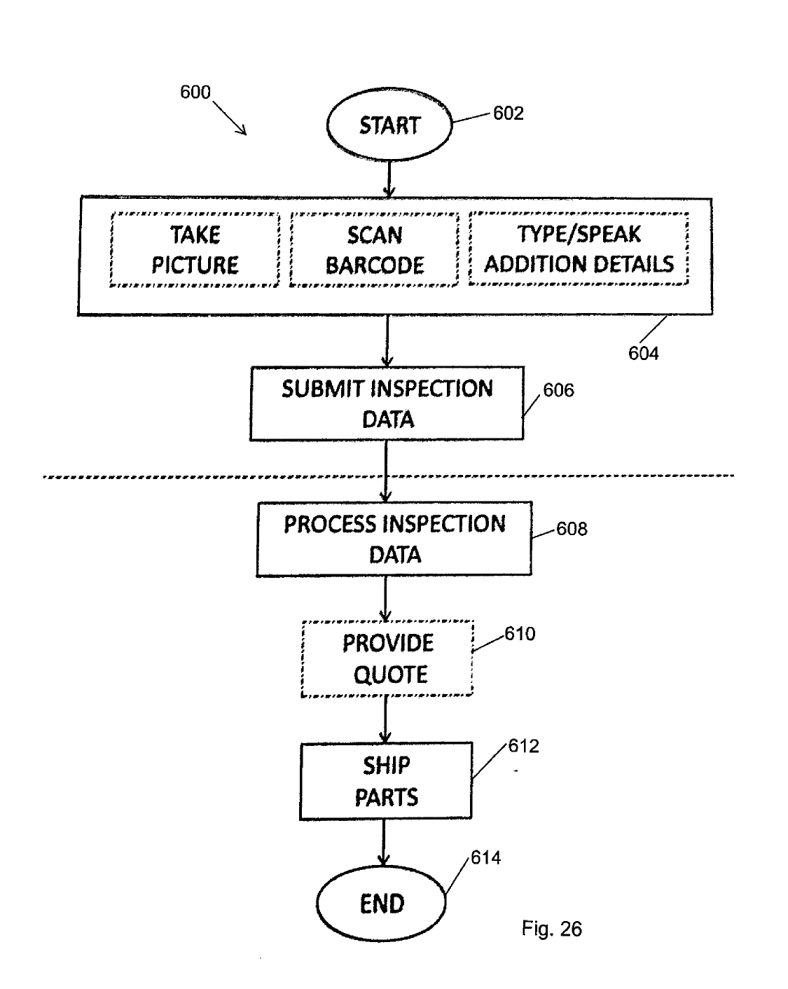

Referring now to FIG. 26, according to at least one embodiment, the equipment maintenance information system 10 can be configured as a management system to monitor the amount of inspections being completed, who is completing the inspections (e.g., log in), schedule inspections, the like, or a combination thereof.

At least one of the detection assembly 12 and the mobile device 14 can include a camera 135 or 136 or other optical reading device, according to at least one embodiment. The camera can be used to monitor parts being inspected (e.g., a tire) to evaluate the condition. In such an example, the camera can be used to capture one or more images of the tire, and a processor can be configured to process the one or more images to evaluate a wear state of the tire (e.g., tire tread condition).

According to at least one embodiment, at least one of the detection assembly 12 and the mobile device 14 can have an imaging device. The detection assembly 12 and/or mobile device 14 can be configured to capture an image and diagnose or classify the an object (e.g., properly working, not properly working, diagnose specific problem, the like, or a combination thereof).

For purposes of explanation and not limitation, an image can be captured of engine exhaust. Data that is representative of the captured imaged (e.g., color patterns against a white or other predetermined background) can be compared to data stored on the database. Additionally or alternatively, a sensor can interpret a mixture of elements.

Additionally or alternatively, the camera and/or other optical reading device can be configured to scan or read a bar code that is unique to the equipment or a part thereof. In such an example, the history or data relating to the equipment or part thereof can be recalled and considered in the evaluation, and additional data collected can be stored associated with this unique identification. This can reduce time for the inspector, as the inspector may avoid manually entering information relating to the particular equipment or part if such information is already stored in a database and associated with the bar code.

According to at least one embodiment, at least one of the detection assembly 12 and the mobile device 14 can have an audible receiving device (e.g., microphone). The detection assembly 12 and/or mobile device 14 can be configured to receive an audible noise and diagnose or classify the noise.

For purposes of explanation and not limitation, if the noise of a running engine can be received by the audible receiving device and a signal representative of the received audible noise can be processed to diagnose potential issues. Thus, the noise can be classified as an engine in good condition or an engine that is not working in good condition. Additionally or alternatively, the noise can be classified or diagnosed to determine the problem with the engine (e.g., misfiring, running too rich/lean, knocking, etc.).

According to at least one embodiment, a database of properly operating device can stored. The noise received by the audible detection device (or features of the noise) can be compared to the stored data in the database. It can then be determined if the received noise in a properly operating device.

Additionally or alternatively, the database can include data relating to devices with known operating problems. The noise received by the audible detection device (or features of the noise) can be compared to the stored data in the database. It can then be determined if the received noise is similar to stored data that is representative of a device having a known operating problem and the problem can be diagnosed.

It should be appreciated by those skilled in the art that any one or combination of noises can be used to classify or diagnose a problem, such as, but not limited to, engine, exhaust, brakes, bearings, the like, or a combination thereof.

According to at least one embodiment, at least one of the detection device 12 and mobile device 14 can include a device for accepting payment. For purposes of explanation and not limitation, if it is determined that a wear state of the part indicates immediate replacement or replacement in the near future by the data collected by the detection device 18, data from the mobile device 12, data from the network 16, or a combination thereof, a replacement part and price can be identified in substantially real-time. The replacement part can then be purchased at the time of inspection by use of a payment device (e.g., credit card reader, credit card information data entry, wire transfer, PAYPAL™ the like, or a combination thereof).

The detection assembly 12, the mobile device 14, or any mobile device configured to be easily carried from a high ambient light condition (e.g., sunny day) to a low ambient light condition (e.g, night, inside a building structure, etc.) can include a video screen and be configured to automatically switch backgrounds to enhance visibility during high ambient light conditions. By way of explanation and not limitation, if the device detects high ambient light conditions (e.g., light sensor, camera, etc.), the device can be configured to automatically control the video screen to emit a white background and black (or other colored) text, images, etc. When the device detects lower ambient light conditions, the device can be configured to automatically control the video screen to emit a black or other colored background a white or other colored text. Thus, the device can be configured to automatically emit a high contrast image in high ambient light conditions.

With respect to FIG. 26, an inspection method is generally shown at reference identifier 600. The method 600 starts at step 602, and proceeds to step 604, wherein an inspection is performed. The inspection can include at least one of, taking a picture of an inspected part, scanning a barcode of the vehicle being inspected and/or the inspected part, typing and/or speaking additional details that are recorded on the device, the like, or a combination thereof. The method 600 then proceeds to step 606, wherein inspection data is submitted. The inspection data is data that is at least partially based upon the data collected in step 604, in accordance with at least one embodiment. Steps 604 and 606 can be performed by someone on an inspection site (e.g., at the location of the equipment that is being inspected).

At step 608, the method 600 can include the step of processing the inspection data. For purposes of explanation and not limitation, the data collected at step 604 can be used to determine additional information, such as, but not limited to, using wear tables, geographical data, etc. The method 600 can then proceed to optional step 610, wherein a quote for replacement parts is provided. Step 610 can be performed if it is determined that replacement parts are needed due to the inspection data captured at step 604, the inspector and/or equipment owner has requested a quote, the like, or a combination thereof.

The method 600 can proceed to optional step 612 from step 608 directly or from step 610, wherein replacement parts are shipped. Replacement parts are shipped if it is determined that replacement parts are needed or recommended, and the buyer has agreed to buy them (e.g., pre-paid, submitted a purchase order, etc.). Steps 608, 610, and 612 can be performed by an inspection manager system, a dealership, an equipment manufacturer, a distributor, etc. The method 600 can then end at step 614.

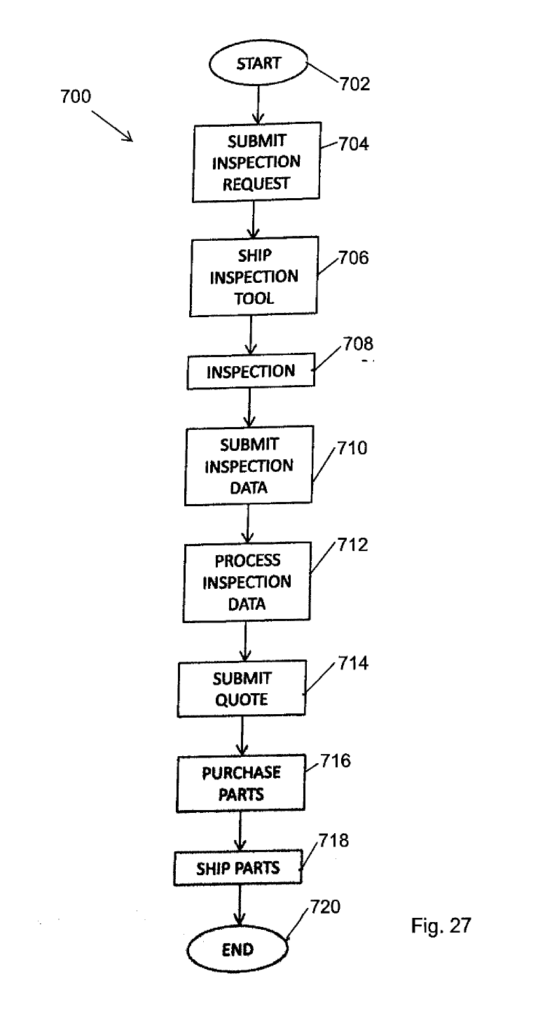

In regards to FIG. 27, an inspection method is generally shown at reference identifier 700. The method 700 can start at step 702, and proceed to step 704, wherein an inspection request is submitted. Such a request can be written (e.g., letter, facsimile, email, internet webpage request, etc.) or oral (e.g., in-person, telephone, etc.). At step 706, the inspection equipment is shipped to the requestor (e.g., detection assembly and/or mobile device).

The method 700 can then proceed to step 708, wherein an inspection is performed. At step 710, the inspection data is submitted, and the inspection data is processed at step 712. At step 714 a quote for replacement parts is submitted, and the replacement parts can be purchased at step 716. The replacement parts are shipped at step 718. The method 700 can then end at step 720. By way of explanation and not limitation, step 708 through step 718 can include one or more steps of the method 200.

Additionally or alternatively, systems 10, 102, 202 and/or methods 152, 252, 600 or 700 can send pre-prequalified real-time digital information as an automated email to a quote team (e.g., inspector) with all pertinent information to define the issue, analyze the problem, create a solution and tie the solution quote and original condition of the failure back to each customer, and serial number of a specific machine. Thus, the systems 10, 102, 202 and/or methods 152, 252, 600, 700 puts the knowledge of a technician, sales person, and technical communicator at the site of the opportunity.

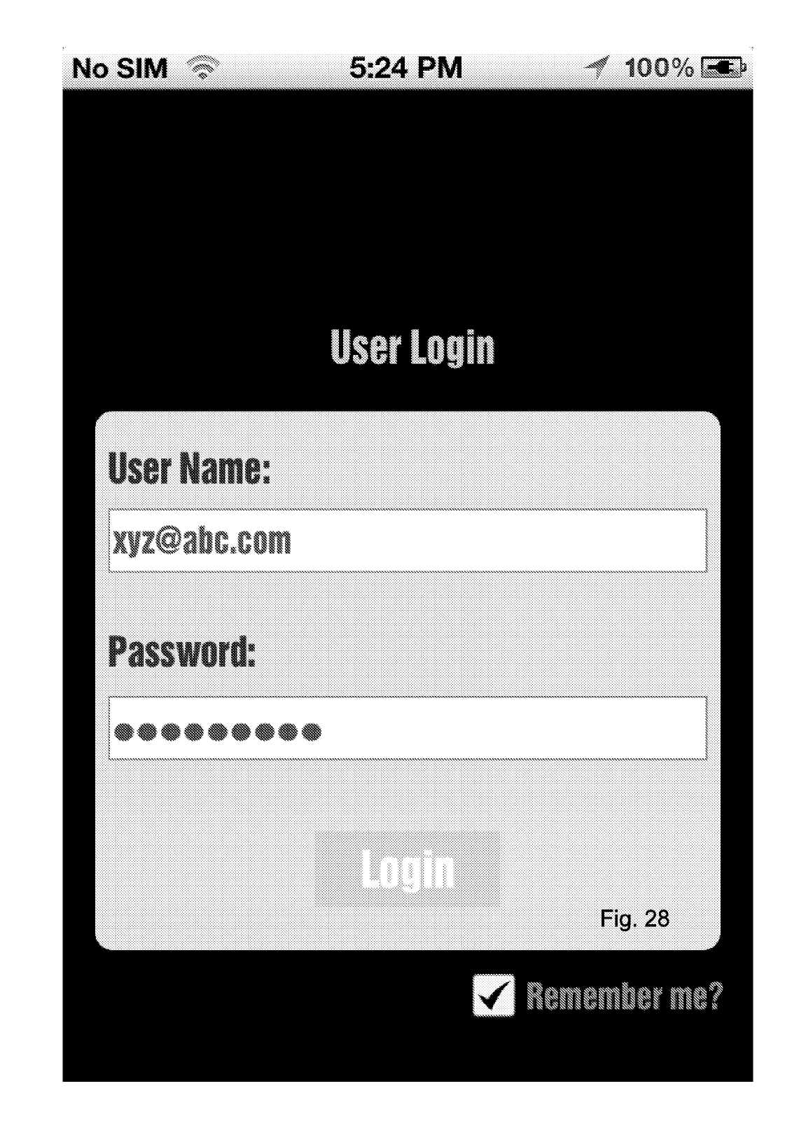

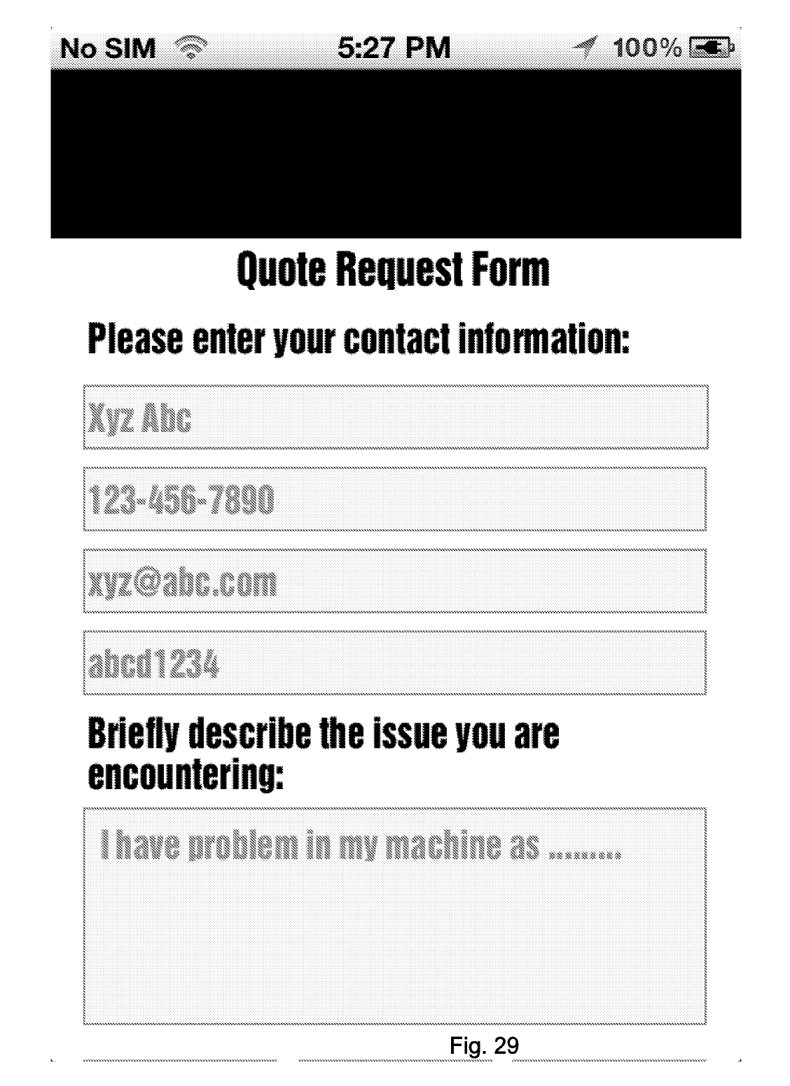

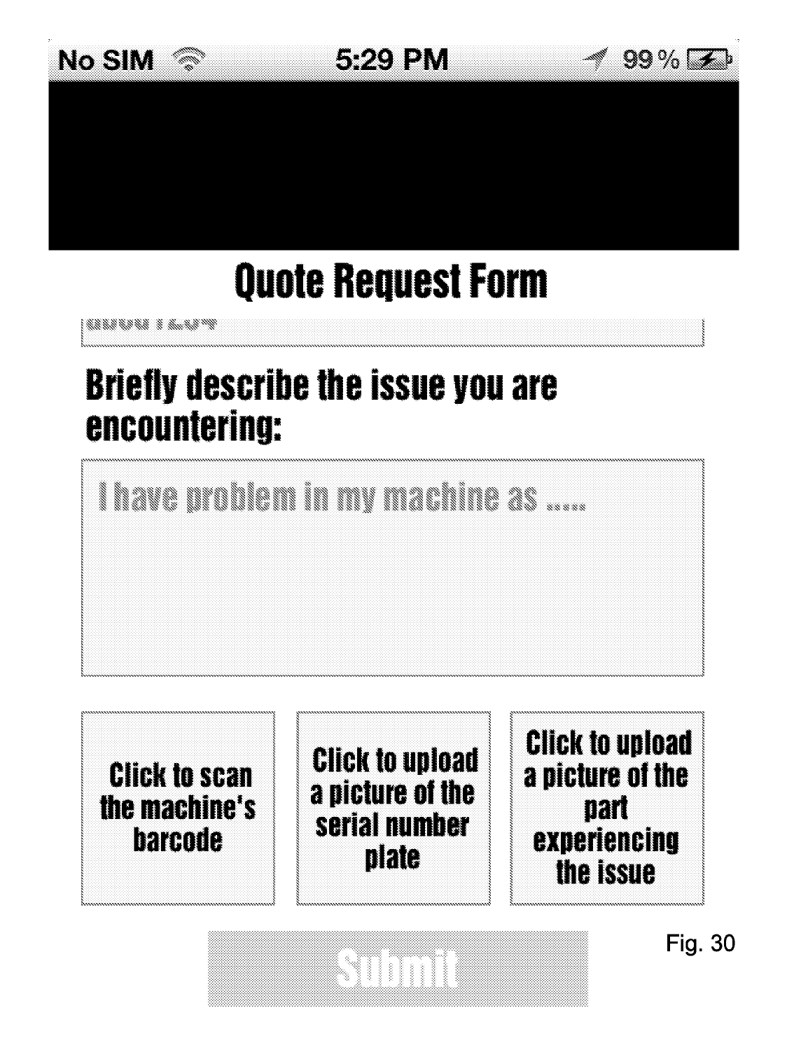

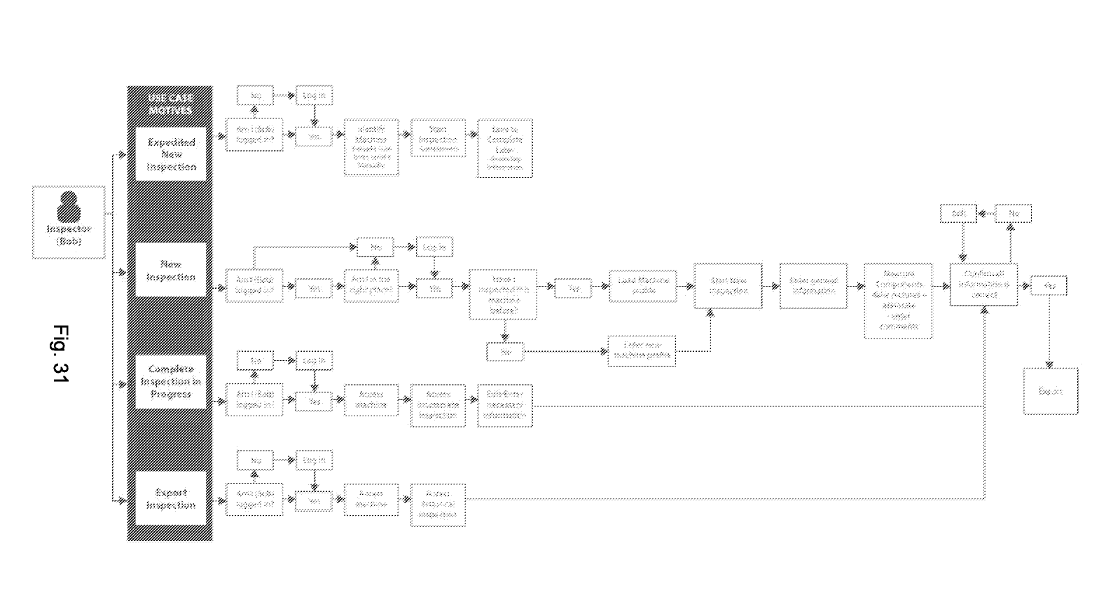

FIGS. 28-30 provide examples of possible user interface screens on a mobile device 14 for login and interaction by a user in the field. FIG. 28 shows a potential login screen. FIG. 29 shows a sample quote request form. FIG. 30 shows a further sample of a quote request form.

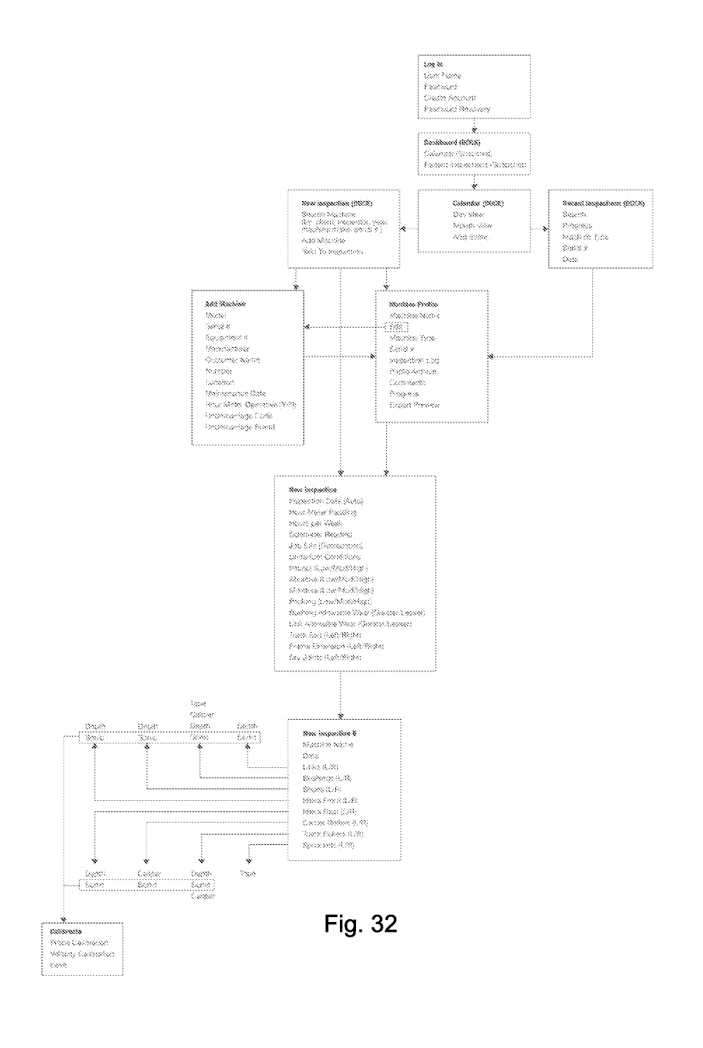

FIGS. 31 and 32 provide flow charts of a possible user interaction with the system 10, from login to a final output.

It should be appreciated by those skilled in the art that system 10 as described herein can be a method and include a non-transitory computer-readable medium having stored thereon, software instructions that when executed by a processor, cause the processor to control the equipment of the controlled vehicle by executing the steps of the method described herein.

It will be appreciated that embodiments of the invention described herein may be comprised of one or more conventional processors and unique stored program instructions that control one or more processors to implement, in conjunction with certain non-processor circuits, some, most, or all of the functions of a method, system, and/or device for equipment maintenance system, as described herein. The non-processor circuits may include, but are not limited to signal drivers, clock circuits, power source circuits, and/or user input devices. As such, these functions may be interpreted as steps of a method used in using or constructing a classification system. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, the methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

It should be further appreciated by those skilled in the art that the above-described components can be connected in additional or alternative ways not explicitly described herein.

Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Features of various embodiments may be used in combination with features from other embodiments. Directional terms, such as “vertical,” “horizontal,” “top,” “bottom,” “front,” “rear,” “upper,” “lower,” “inner,” “inwardly,” “outer,” “outwardly,” “forward,” and “rearward” are used to assist in describing the invention based on the orientation of the embodiments shown in the illustrations. The use of directional terms should not be interpreted to limit the invention to any specific orientation(s). Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. An equipment maintenance information system comprising:
a detection assembly configured to detect a condition of at least one part of the equipment;
a mobile device communicatively connected to said detection assembly by a first wireless communicative connection, wherein said mobile device is configured provide substantially real-time data based upon an output received from said detection assembly; and
a database containing information regarding the at least one part of the equipment, wherein said substantially real-time data is based upon data received from said database.

2. The equipment maintenance information system of claim 1 wherein said detection assembly includes an ultrasonic device.

3. The equipment maintenance information system of claim 1 wherein said detection assembly is removably attached to said mobile device.

4. The equipment maintenance information system of claim 3 wherein said detection assembly is housed within a case, said case removably attached to said mobile device.

5. The equipment maintenance information system of claim 4 wherein said case includes a substrate extending over a surface of said mobile device, and a sidewall extending from said substrate to retain said mobile device, wherein said sidewall includes a spring-loaded portion that articulates with respect to said substrate to retain said mobile device.

6. The equipment maintenance information system of claim 1 including a network communicatively connected to said mobile device by a second wireless communicative connection, said database contained on said network.

7. The equipment maintenance information system of claim 6 wherein said database includes wear data relating to the equipment, and wherein said substantially real-time data is based upon both an output received from said detection assembly relating to an amount of wear for the equipment and data received from said network relating to said wear data.

8. The equipment maintenance information system of claim 1 wherein said database further includes pricing information for the model of the equipment, wherein said substantially real-time data further includes said pricing information.

9. The equipment maintenance information system of claim 1 wherein said mobile device includes an internal memory, and database is contained on said internal memory.

10. A detection assembly comprising:
a detection device configured to detect a wear condition of at least one part of equipment;
a processor communicatively connected to said detection device, said processor configured to process data received from said detection device;
a transceiver communicatively connected to said processor, said transceiver configured to wirelessly transmit and receive data with a mobile device, such that the mobile device is configured to emit an output based upon said wear condition for said at least one part of said equipment and data received from monitoring a corresponding piece of equipment in substantially real-time.

11. A mobile device comprising:
a first transceiver configured to wirelessly transmit and receive data with a detection assembly by a first wireless communicative connection;
a second transceiver configured to wirelessly transmit and receive data with a network by a second wireless communicative connection;
a processor configured to process information received from at least one of the detection assembly and the network;
a display device configured to emit at least one image based upon said processed data;
an audible enunciator configured to emit at least one audible sound based upon said processed data;
wherein said mobile device is configured to emit an output based upon wear data for equipment components and data received from monitoring a corresponding piece of equipment in substantially real-time.

12. The mobile device of claim 11 wherein said image emitted by said display device relates to a real-time status of said operation of said detection assembly and wherein said audible sound emitted by said audible enunciator relates to a real-time status of said detection assembly, wherein said image and said audible sound are capable of alerting an operator to an improper measurement by said detection assembly.

13. A method for equipment maintenance comprising the steps of:
detecting a condition of at least one part of the equipment;
communicating, wirelessly by a first wireless communicative connection, data based upon said detected condition;
providing a substantially real-time output corresponding to said data based upon said detected condition;
communicating, wirelessly by a second wireless communicative connection, wear data from a database; and
providing a substantially real-time output corresponding to said data based upon said detected condition and said wear data from said database.

14. The method of claim 13, wherein at least one of said detection assembly, said mobile device, and said database are configured to emit inspection instructions.

15. The method of claim 14 wherein said emitting comprises at least one of an audible output and a visual output.

16. The method of claim 13 wherein at least one of said detection assembly, said mobile device, and said database are configured to emit at least one indication based upon said condition detected by said detection assembly.

17. The method of any of claim 13 wherein said mobile device is configured to emit an alert regarding an improper measurement taken by said detection assembly based upon at least one of said detected part, said detected condition, and said wear data.

18. A detection system comprising:
a detector configured to detect a condition of a wear part;
a mobile device communicatively connected to said detector; and
wherein said detector is configured to removably attach to said mobile device, and said mobile device is configured to emit an output based upon data received from said detector.

19. The detection system of claim 18, wherein said detector is an ultrasonic detector.

20. The detection system of claim 19 configured to detect a wear condition of a part of a heavy duty construction equipment vehicle.

21. The detection system of claim 18 wherein said removable connection between said detection assembly and said mobile device includes a portion of said detector that is spring loaded such that it is biased against a portion of said mobile device.

22. A method for inspecting parts of a heavy duty equipment vehicle, said method comprising the steps of:
collecting inspection data from the heavy duty equipment vehicle by at least one of taking picture, scanning a barcode, typing details, and speaking details;
submitting the inspection data;
processing the inspection data to determine one of a class, make and a model of the heavy duty equipment vehicle;
providing a quotation for at least one replacement part for the heavy duty equipment vehicle based on said determination of said one of said class, make and model; and
shipping said at least one replacement part to a customer.

23. A method for inspecting parts of a heavy duty equipment vehicle, said method comprising the steps of:
submitting an inspection request;
shipping at least one inspection tool;
performing an inspection;
submitting inspection data;
processing inspection data;
submitting a quotation for at least one replacement part;
purchasing at least one replacement part; and
shipping said at least one purchased replacement part.

24. A system configured for inspecting parts of a heavy duty equipment vehicle, said system comprising:
a detection assembly;
a mobile device in communication with said detection assembly;
a database in communication with said mobile device; and
wherein at least one of said detection assembly and said mobile device comprises an audible receiving device, and is configured to classify a received sound, and to diagnose a condition of a part making the received sound based on a characteristic of the received sound.

25. A method for maintaining a vehicle comprising:
providing a database of machines, wherein each machine is related to at least one equipment model and each equipment model is related at least one component;
providing at least one historical measurement the at least one component, wherein the at least one historical measurement is based on a measurement of the at least one component or an estimated measurement of the at least one component;
measuring a first component of a first machine; and
determining a wear rate of the first component based in part on the measurement of the first component and the at least one historical measurement of an at least one component related to the first component.

26. The method of claim 25, further comprising:
providing a first equipment model of the first machine; and
generating a default inspection form for performing a maintenance inspection on a vehicle based on the components related to the provided first equipment model, the inspection form including a list of inspection instructions for the first equipment model.

27. The method of claim 26, further comprising:
providing tolerance data related to the at least one component,
providing a first equipment model and a first component related to the first equipment model, wherein the first component is similar to the at least one component; and
determining a tolerance related to the first component based in part on the tolerance data related to the at least one component.

28. The method of claim 27, further comprising:
providing historical wear data related to the at least one component,
providing a first equipment model and a first component related to the first equipment model, wherein the first component is similar to the at least one component; and
determining an estimated wear rate related to the first component based in part on the wear data related to the at least one component.

29. The method of claim 28, further comprising:
providing historical data related to a first machine, wherein the historical data includes one or more measurements of a first component of the first machine; and
determining an estimated wear rate of the first component of the first machine, wherein the estimated wear rate is based in part on the historical data.

30. The method of claim 29, further comprising providing a geographic location, an equipment model, a use profile, and a configuration of a second machine, the second machine having at least one component.

31. The method of claim 30, further comprising generating a default inspection parameter for the at least one component of the second machine based in part on at least one of the geographic location, the equipment model, the use profile, and the configuration of a second machine.

32. The method of claim 31, further comprising:
providing a geographic location, an equipment model, a use profile, and a configuration of the second machine; and
determining a predicted wear rate of the at least one component of the second machine based in part on a measured wear rate of at least one component of the first machine, the first machine having in common with the second machine at least one of a common geographic location, a common equipment model, a common use profile, and a common configuration.

33. The method of claim 32, further comprising:
providing a geographic location, an equipment model, a use profile, and a configuration of the second machine; and
providing a recommendation for at least one of maintenance and configuration of the second machine based in part on a measured wear rate of at least one component of the first machine, the first machine having in common with the second machine at least one of a common geographic location, a common equipment model, a common use profile, and a common configuration.

34. A portable electronic device comprising:
a tablet computer including a power source;
a case having an outer surface and an interior, the tablet computer being positioned at least partially in the interior of the case; and
an electronic circuit board positioned between the case and the power source, wherein the electronic circuit board generates heat when receiving electrical power from the power source, at least a portion of the heat being transferred to the power source.
